(19) United States
(12) Patent Application Publication
(10) Pub. No.: US 2008/0244155 A1
(43) Pub. Date: Oct. 2, 2008

(54) METHODS AND APPARATUS TO PROTECT DYNAMIC MEMORY REGIONS ALLOCATED TO PROGRAMMING AGENTS

(76) Inventors: Kyungwoo Lee, West Lafayette, IN (US); Prashant Dewan, Hillsboro, OR (US); Uday Savagaonkar, Beaverton, OR (US)

Correspondence Address: Hanely Flight & Zimmerman, LLC, 150 S. Wacker Drive, Suite 2100, Chicago, IL, 60606, US

(21) Appl. No.: 11/694,447

(22) Filed: Mar. 30, 2007

(51) Int. Cl. G06F 12/02

(52) U.S. Cl. 711/6; 711/207

(57) ABSTRACT

Methods and apparatus to protect dynamic memory regions allocated to programming agents are disclosed. An example method to protect a dynamic memory region disclosed herein comprises mapping protected memory regions to a protected page table for address translation associated with a protected agent, updating the protected page table with address information corresponding to the dynamic memory region during a context switch from execution of an unprotected agent to execution of the protected agent when the dynamic memory region was allocated for the unprotected agent prior to the context switch, and accessing the dynamic memory region during execution of the protected agent based on the address information in the protected page table without causing a subsequent context switch.

### FIELD OF THE DISCLOSURE

This disclosure relates generally to memory protection and, more particularly, to methods and apparatus to protect dynamic memory regions allocated to programming agents.

### BACKGROUND

Virtualization allows a hardware platform to support one or more virtual machines simultaneously. Virtualization is achieved through a virtual machine monitor that abstracts the hardware platform for each virtual machine. As such, each virtual machine provides an independent execution environment running an independent operating system. The operating system in each virtual machine may operate as if it has sole control of the hardware platform. In particular, a virtual machine's operating system expects to maintain control of address translation mechanisms used to access the physical instruction and data memory regions of the hardware platform. The virtual machine monitor abstracts the control of the address translation mechanisms to the virtual machines and, thus, retains ultimate control over address translation on the hardware platform.

As part of the abstracted address translation mechanism, the virtual machine monitor may provide support for memory protection. A programming agent executing in a virtual machine may register for memory protection. If memory protection is granted, the virtual machine monitor abstracts mechanisms by which the protected programming agent can be executed in a protected context. In the protected context, access to specified instruction and data memory regions associated with the protected agent is restricted. However, context switches between unprotected contexts and protected contexts can incur significant processing overhead, thereby limiting the overall performance of the virtual machine executing the protected agent.

### BRIEF DESCRIPTION OF THE DRAWINGS

FIG. 1 is a block diagram of an example platform to provide protection of dynamic data memory regions associated with programming agents.

FIG. 2A is a block diagram of an example descriptor table agent module (DTAM) that may be used in the example platform of FIG. 1.

FIG. 2B illustrates an example entry of an example descriptor table maintained by the example DTAM of FIG. 2A.

FIG. 3 is a block diagram of an example descriptor table virtual machine monitor module (DTVM) that may be used in the example of FIG. 1.

FIG. 4 is a block diagram of an example page fault handler that may be used in the example of FIG. 1.

FIGS. 5A-5B collectively are flowcharts representative of example machine readable instructions that may be executed to implement the example DTAM of FIG. 2A and portions of the example DTVM of FIG. 3 to process descriptor tables associated with a protected programming agent.

FIG. 6 is a flowchart representative of example machine readable instructions that may be executed to implement the example page fault handler of FIG. 4.

FIG. 7 is a flowchart representative of example machine readable instructions that may be executed to implement an example instruction fetch fault handler for use by the example page fault handler of FIG. 4 and/or the example machine readable instructions of FIG. 6.

FIG. 8 is a flowchart representative of example machine readable instructions that may be executed to implement a first example DTVM descriptor table update component (DTVMU1) for use by the example DTVM of FIG. 3 and/or the example machine readable instructions of FIG. 7

FIG. 9 is a flowchart representative of example machine readable instructions that may be executed to implement a second example DTVM descriptor table update component (DTVMU2) for use by the example DTVM of FIG. 3 and/or the example machine readable instructions of FIG. 7

FIG. 10 is a flowchart representative of example machine readable instructions that may be executed to implement an example process to open memory protection for use by the example machine readable instructions of FIG. 7

FIG. 11 is a flowchart representative of example machine readable instructions that may be executed to implement an example process to close memory protection for use by the example machine readable instructions of FIG. 7.

FIG. 12 is a flowchart representative of example machine readable instructions that may be executed to implement an example data access fault handler for use by the example page fault handler of FIG. 4 and/or the example machine readable instructions of FIG. 6.

FIG. 13 is a flowchart representative of example machine readable instructions that may be executed to implement an example process to handle dynamic data for use by the example machine readable instructions of FIG. 12.

FIG. 14 is a block diagram of an example computer that may execute the example machine readable instructions of FIGS. 5A-5B, 6-12 and/or 13 to implement the example platform of FIG. 1.

### DETAILED DESCRIPTION

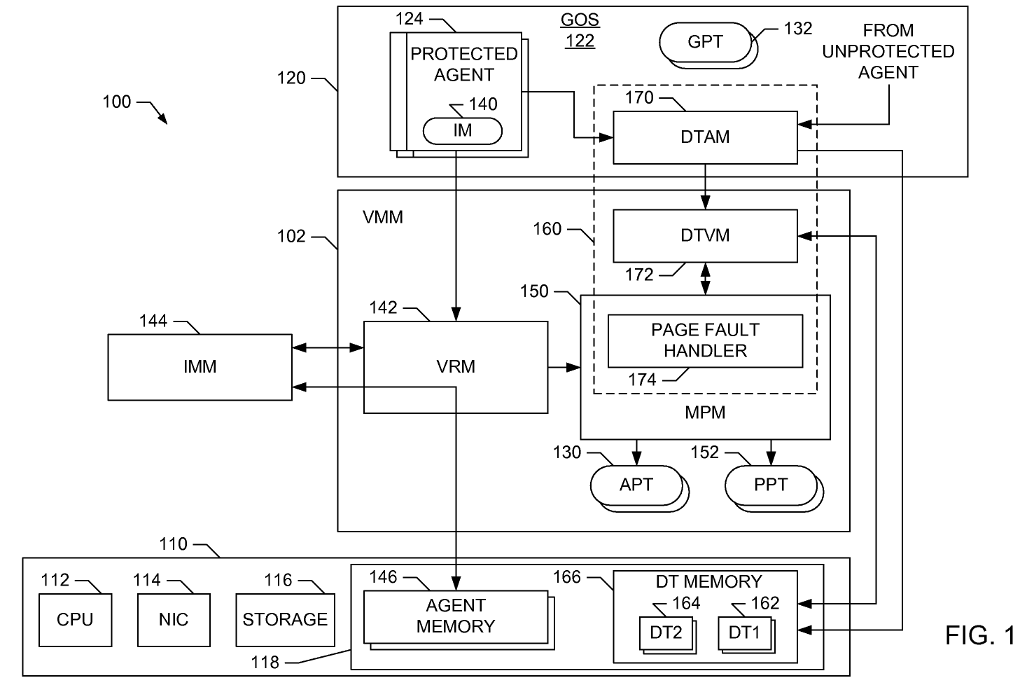

An example platform 100 to provide protection of dynamic memory regions associated with programming agents is illustrated in FIG. 1. The example platform 100 includes a virtual machine monitor (VMM) 102 to present multiple abstractions and/or views of the platform hardware 110 for one or more virtual machines (VMs) 120. The platform hardware 110 of the illustrated example includes one or more processor(s) 112, a network interface controller 114, storage 116, and host memory 118. The VM 120 provides an independently operating execution environment capable of executing code independently and securely isolated from other VMs. While the example platform 100 includes a single VM 120, other example implementations may employ any number of VMs.

Furthermore, while FIG. 1 illustrates execution environments in the form of virtual partitions, some example implementations may provide separate execution environments through other mechanisms, such as, for example, using separate service processors and/or embedded microcontrollers. Also, in other example implementations, an auxiliary environment may be partitioned from a host environment via a variety of different types of partitions including, for example, a virtualized partition (e.g., a virtual machine in a Virtualization Technology (VT) scheme) and/or an entirely separate hardware partition (e.g., such as via Active Management Technologies (AMT), Manageability Engine (ME), Platform Resource Layer (PRL) using sequestered platform resources, System Management Mode (SMM), and/or other comparable or similar technologies).

In the example platform 100 of FIG. 1, the VM 120 includes a guest operating system (GOS) 122 for executing one or more agents 124 in the VM 120. In a non-virtualized platform, the GOS 122 would have direct control of the platform hardware 110. However, in the virtualized platform 100 of FIG. 1, the GOS 122 actually has only indirect control of the platform hardware 110 through the VM 120 and VMM 102. Through such an abstraction, each agent 124 can operate as if it were executing on a dedicated computer rather than a virtual machine. That is, different agents 124 operating in their respective VMs may each expect to control various events and utilize functionality to the platform hardware 110 through their respective GOSs 122. Although the example platform 100 shows one agent 124 operating in the VM 120, any number of agents may operate in each VM of the platform 100. In turn, the VMM 102 manages access to the platform hardware 110 by the agent 124 executing in the VM 120. The VMM 102 may be implemented in software as, for example, a stand-alone program and/or an agent of a host operating system. Alternatively, the VMM 102 may be implemented in hardware, firmware, and/or any combination of software, hardware and/or firmware.

As used herein, the terms “agent” and “programming agent” both refer to programming logic and associated data that may be employed to obtain a desired outcome. The term agent or programming agent may be synonymous with module, agent, application, program, etc., and may also refer to programming logic that may be embodied in hardware or firmware, or in a collection of software instructions, possibly having entry and exit points, written in a programming language, such as, for example, C++, Intel Architecture 32 bit (“IA-32”) executable code, etc. Example agents 120 include, but are not limited to, supervisory-level agents (e.g., such as kernel agents to provide services such as loader(s), scheduler(s), memory manager(s), etc.), extensions/drivers (e.g., such as for network cards, universal serial bus (USB) interfaces, disk drives, etc.), service-driver hybrids (e.g., such as intrusion detectors to observe execution of code), etc.

An agent may be compiled and linked into an executable program, installed in a dynamic link library, written in an interpretive language such as BASIC, etc. Such software agents may be callable from other agents and/or invoked in response to detected events, such as, for example, interrupts, exceptions, faults, etc. Instructions for agents may be provided in a machine readable medium that, when executed, causes a machine to perform operations. Examples of machine readable mediums include, but are not limited to, firmware (e.g., an electrically erasable programmable read-only memory (EEPROM), read-only memory (ROM), random access memory (RAM), magnetic disk storage, optical disk storage, etc.), hardware (e.g., connected logic units, gates, flip-flops, programmable gate arrays or processors, etc.), and/or combinations thereof.

For example, storage 116 may represent non-volatile storage to store persistent content to be used for the execution of the agents on the example platform 100, such as, for example, program files (which may include links to other routines and/or data segments), configuration files, executable files, code segments, dynamic linked libraries (DLLs), etc. In other examples, the storage 116 may include integrated and/or peripheral storage devices, such as, for example, disks and associated drives (e.g., magnetic, optical), universal serial bus (USB) storage devices and associated ports, flash memory, ROM, non-volatile semiconductor devices, etc. The storage 116 may also be a storage resource resident in the example platform 100 or the storage 116 may be accessible by, but not necessarily resident in, the platform 100. For example, the storage 116 may be accessed by the example platform 100 over a network via the network interface controller 114.

As mentioned previously, the access to the platform hardware 110 from the VM 120 is managed by the VMM 102. In particular, the VMM 102 controls access to the physical memory of the platform hardware 110, including the host memory 118. The VMM 102 maintains control of the physical memory (e.g., including the host memory 118) through a set of parallel page tables for each GOS 122 in the example platform 100. In particular, the VMM 102 maintains a set of active page tables (APTs) 130 that reference the actual physical memory (e.g., including the host memory 118) of the platform hardware 110 for address translation by the one or more processors 112. Each GOS 122, in turn, maintains its own guest page tables (GPTs) 132 for virtual address translation within the VM 120. The VMM 102 synchronizes the GPTs 132 with the APTs 130 using any appropriate synchronization procedure, such as, for example, the virtual translation lookaside buffer (VTLB) procedure described in U.S. Pat. No. 6,907,600.

Furthermore, the example platform 100 supports intra-partitioning to protect agents executing in the GOS 122 from other components of the same operating system. For example, the agent 124 may be selected for intra-partitioning. In such an example, the GOS 122 and/or the VMM 102 may identify and partition off portions of the agent 124 to restrict access by the GOS 122. Partitioned portions may include any portion or all of the instruction memory and/or the data memory associated with the agent 124. A partitioned portion may be sequestered, either physically or virtually, from other agents within the same execution environment, such that intra-execution environment accesses may be monitored and restricted. Intra-partitioning may facilitate insulation of the agent 124 from the GOS 122 without requiring the agent 124 to operate in an entirely separate execution environment and/or a separate OS. Intra-partitioning may also provide the agent 124 with a level of protection from other agents executing in the same GOS 122, even those of similar or higher privilege levels, within the example platform 100 that may be compromised in some manner (e.g., such as malware, critical runtime failures, etc.).

To achieve protection through intra-partitioning, the agent 124 includes an integrity manifest (IM) 140. The IM 140 of the illustrated example is a data structure that describes the configuration of the agent 124 when it is loaded correctly into memory. The integrity manifest 140 of the illustrated example is also cryptographically signed by the vendor, trusted source, etc., associated with the agent 124. At an appropriate time, the agent 124 issues a registration request for memory protection to the VMM 102 and, more particularly, to an intra-partitioning registration module (VRM) 142 of the VMM 102. For example, such registration may be invoked prior to the GOS 122 loading the agent 124 into memory (e.g., such as the host memory 118) and the agent 124 beginning execution. In some example implementations, the agent 124 may be registered only once and the agent 124 will not be allowed to execute until it is successfully registered and protected. In other example implementations, registration may be invoked periodically and/or in some other event-driven manner. Furthermore, registration may also be initiated by another agent within the example platform 100, such as, for example, another agent executing in the GOS 122, an agent executing in another VM, the VMM 102, etc.

Upon receiving the registration request, the VRM 142 of the illustrated example forwards the registration request and the integrity manifest 140 of the agent 124 to an integrity measurement module (IMM) 144 to verify the integrity of the agent 124. The IMM 144 may reside in the same hardware as the VMM 102 or in separate hardware accessible by the VMM 102. Integrity verification of the agent 124 may be used by the example platform 100 to prevent unauthorized modification and/or malicious termination of the protected agent 140. Furthermore, integrity verification ensures that only recognized agents are afforded protection within the example platform 100. For additional security, the IMM 144 of the illustrated example is sequestered in separate hardware such that intra-execution environment accesses are restricted. The IMM 144 provides a response to the VRM 142 indicating the results of integrity verification. Example integrity verification results include pass, fail, pass with qualification, fail with qualification, etc. Such qualifications may reflect degrees of integrity verification between pass and fail.

To perform integrity verification, the IMM 144 first validates the cryptographic signature included with the integrity manifest 140 to verify that the integrity manifest 140 is associated with a trusted vendor, a trusted source, etc. Additionally, signature validation ensures that the integrity manifest 140 has not been altered. Next, IMM 144 compares the configuration information included in the integrity manifest 140 with the actual image of the protected agent 124 that is stored in the physical host memory 118, for example, in an agent memory region 146 allocated to the agent 124. For example, the agent memory region 146 may include the program code and initialized data associated with the agent 140. In the illustrated example, the VRM 142 measures the contents of the agent memory region 146 and sends the content measurement information to the IMM 144 along with the registration request and the integrity manifest 140. The IMM 144, in turn, compares the measured contents in the agent memory region 146 with the configuration included in the integrity manifest 140. If the signature verification fails or the contents of the agent memory region 146 do not match the configuration included in the integrity manifest 140, the IMM 144 indicates an integrity verification failure to the VRM 142.

However, if the signature verification succeeds and the contents of the agent memory region 146 match the configuration included in the integrity manifest 140, the IMM 144 indicates an integrity verification success to the VRM 142. The VRM 142 may then cooperate with a memory protection manager (MPM) 150 to configure run-time memory protection for the agent 124. In the illustrated example, the VRM 142 forwards the registration request to the MPM 150. In response to the registration request, the MPM 150 creates a protected page table (PPT) 152 for the program code and static data memory corresponding to the agent 124 requesting memory protection. The MPM 150 then provides runtime memory protection by removing any references to the program code and static data memory corresponding to the agent 124 from the APT 130. As such, the MPM 150 enforces separation of the address spaces represented by APT 130 and PPT 152. To achieve runtime memory protection for the agent 124, the MPM 150 of the illustrated example adjusts the page table base address register (e.g., such as CR3 in the Intel® IA-32 architecture) to point to APT 130 or PPT 152 only upon appropriate page faults. Additionally, the MPM 150 may enforce various system policies, such as preventing invalid jumps into the program code of the agent 124. Furthermore, the MPM 150 may disallow outside read and/or write access into the protected data of the agent 124

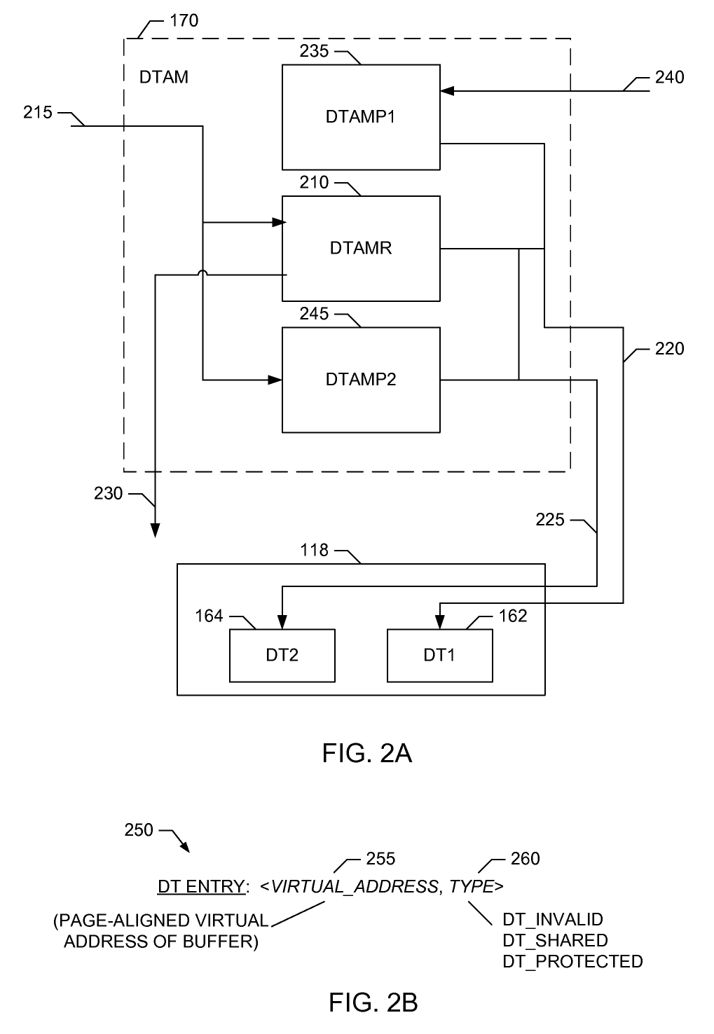

To protect dynamic data memory associated with an agent, such as the agent 124, the example platform 100 includes a dynamic data memory protection module (DDMPM) 160. The DDMPM 160 provides protection for dynamically allocated data memory that is accessible by both a protected agent (e.g., such as the agent 124) and an unprotected agent without incurring additional data-access page faults. The DDMPM 160 utilizes two descriptor (DT) tables, DT1 162 and DT2 164, located in a descriptor table memory region 166 of the host memory 118. DT1 162 and DT2 164 each contain table entries for memory regions to be made accessible between unprotected and protected contexts. As discussed in greater detail below in connection with FIG. 2B, each entry in DT1 162 and DT2 164 includes a virtual address for the dynamic data memory region and associated type information indicating whether the memory region is to be protected or shared.

The DDMPM 160 includes a DT agent module (DTAM) 170, a DT VMM module (DTVM) 172 and a page fault handler 174. In the illustrated example, the DTAM 170 operates in the GOS 122, the DTVM 172 operates in the VMM 102 and the page fault handler 174 operates in the MPM 150. In response to a DT registration request by the agent 124, the DTAM 170 performs a DT registration in which the DTAM 170 allocates memory for DT1 162 and DT2 164 and sends the virtual addresses of the allocated memory to the DTVM 172. In some example implementations, the DTAM 170 performs the DT registration only once for each agent to be protected (e.g., such as the agent 124). The DTAM 170 is also responsible for populating DT1 162 and DT2 164 with the address and type information for the dynamic data memory regions to be accessible after a context switch from an unprotected context to the protected context, from the protected context to the unprotected context, or from the protected context to another protected context.

In response to context switches associated with protected agents (e.g., such as agent 124), the DTVM 172 updates APT 130 and PPT 152 based on the table entries included in DT1 162 and DT2 164. For example, when an unprotected agent invokes the protected agent 124, the unprotected agent updates entries in DT1 162 with information corresponding to any dynamic data memory regions to be made accessible by the protected agent 124. Upon a switch to the protected context for executing the protected agent 124, the DTVM 172 accesses DT1 162 and maps these dynamic data memory regions to PPT 152 to make them accessible by the protected agent 124. Additionally, the DTVM 172 may unmap the listed dynamic data regions from APT 130 if these regions are to be protected during execution of the protected agent 124. In another example, when the protected agent 124 invokes an unprotected agent, the protected agent 124 updates entries in DT2 164 with information corresponding to any dynamic data memory regions to be made accessible by the unprotected agent. Upon a switch to the unprotected context for executing the unprotected agent, the DTVM 172 accesses DT2 164 and maps these dynamic data memory regions to APT 130 to make them accessible by the unprotected agent. Additionally, the DTVM 172 unmaps the listed dynamic data regions from PPT 152 because these memory regions are no longer associated with a protected agent. As a result, upcoming data access page faults on the dynamic data memory region can be prevented because the dynamic memory regions are already made accessible in the appropriate context.

The page fault handler 174 processes page faults associated with protected agents (e.g., such as agent 124) and unprotected agents. In particular, the page fault handler 174 processes two types of page faults: instruction fetch page faults and data access page faults. Instruction fetch page faults occur, for example, upon a context switch from one agent to another agent. When an instruction fetch page fault occurs, the page fault handler 174 invokes the DTVM 172 to update the APT 130 and PPT 152 page tables. Data access page faults occur, for example, when an agent accesses data for the first time. When a data access page fault occurs, the page fault handler 174 invokes the MPM 150 to process the data access page fault according to available memory protection system policies.

A block diagram of an example implementation of the DTAM 170 that may be used to implement the example platform 100 of FIG. 1 is illustrated in FIG. 2A. The example DTAM 170 of FIG. 2A includes a DTAM registration component (DTAMR) 210 to process DT registration requests received via a protected agent interface 215. The protected agent interface 215 of the illustrated example is configured to interface with protected agents operating in a VM, such as, for example, the agent 124 operating in the VM 120 of FIG. 1. In response to the DT registration request received from, for example, the agent 124, the example DTAMR 210 allocates memory regions in the host memory 118 for the descriptor tables DT1 162 and DT2 164 associated with the agent 124. The example DTAMR 210 allocates memory for DT1 162 via a DT1 memory interface 220 and for DT2 164 via a DT2 memory interface 225. Persons having ordinary skill in the art will appreciate that the DT1 memory interface 220 and the DT2 memory interface 225 may be implemented as a common interface to the host memory 118 or as separate interfaces.

In the illustrated example, the size of the descriptor tables DT1 162 and DT2 164 is specified as a platform configuration parameter and determines the number of dynamic data memory regions that may be made accessible across protection contexts. Furthermore, in the illustrated example, each entry in the descriptor tables DT1 162 and DT2 164 represents a dynamic data memory region to me made accessible across protection contexts. An example descriptor table entry 250 is shown in FIG. 2B. The descriptor table entry 250 includes a virtual address 255 and a type field 260. In the illustrated example of FIG. 2B, the entry 250 corresponds to a dynamic data region having a fixed size equal to the page size (e.g., 4 Kbytes). As such, the page-aligned virtual base address 255 fully specifies the location and size of the dynamic data memory region. Alternatively, an example descriptor table entry 250 could include an additional size field (not shown) to enable mapping of dynamic memory regions having variable lengths. Three types 260 are supported by the type field of the illustrated example. The DTAMR 210 initializes each descriptor entry type field 260 to DT_INVALID to indicate that the entry 250 is not in use. The type DT_PROTECTED indicates that the dynamic data memory region corresponding to the descriptor table entry 250 is to be accessible only in the protected context. The type DT_SHARED indicates that the dynamic data memory region corresponding to the descriptor table entry 250 is to be shared across both the protected context and the unprotected context.

Returning to FIG. 2A, after allocation and initialization of DT1 162 and DT2 164, the example DTAMR 210 forwards the DT registration request via a DT registration interface 230 to, for example, the DTVM 172 of FIG. 1. The DT registration request forwarded by the DTAMR 210 includes the virtual addresses of the allocated memory for the DT1 162 and DT2 164 to enable the DTVM 172 to configure access to these descriptor tables.

The example DTAM 170 of FIG. 2A also includes a DTAM DT1 population component (DTAMP1) 235 to process the DT1 descriptor tables associated with protected agents, such as, for example, the DT1 162 associated with agent 124. The example DTAMP1 235 is invoked via an unprotected agent interface 240 prior to a transition from the unprotected context to the protected context. For example, an unprotected agent may invoke the example DTAMP1 235 prior to calling a protected agent, such as, for example, the agent 124. When invoked, the example DTAMP1 235, via the DT1 memory interface 220, populates the descriptor table entries in DT1 162 corresponding to each dynamic data memory region to be made accessible by the agent 124 in the protected context.

Similarly, the example DTAM 170 of FIG. 2A also includes a DTAM DT2 population component (DTAMP2) 245 to process the DT2 descriptor tables associated with protected agents, such as, for example, the DT1 162 associated with agent 124. The example DTAMP2 235 is invoked via the protected agent interface 215 prior to a transition from the protected context to the unprotected context. For example, a protected agent, such as, for example, the agent 124, may invoke the example DTAMP2 245 prior to calling an unprotected agent. When invoked, the example DTAMP2 235, via the DT2 memory interface 225, populates the descriptor table entries in DT2 164 corresponding to each dynamic data memory region to be made accessible by the unprotected agent in the unprotected context.

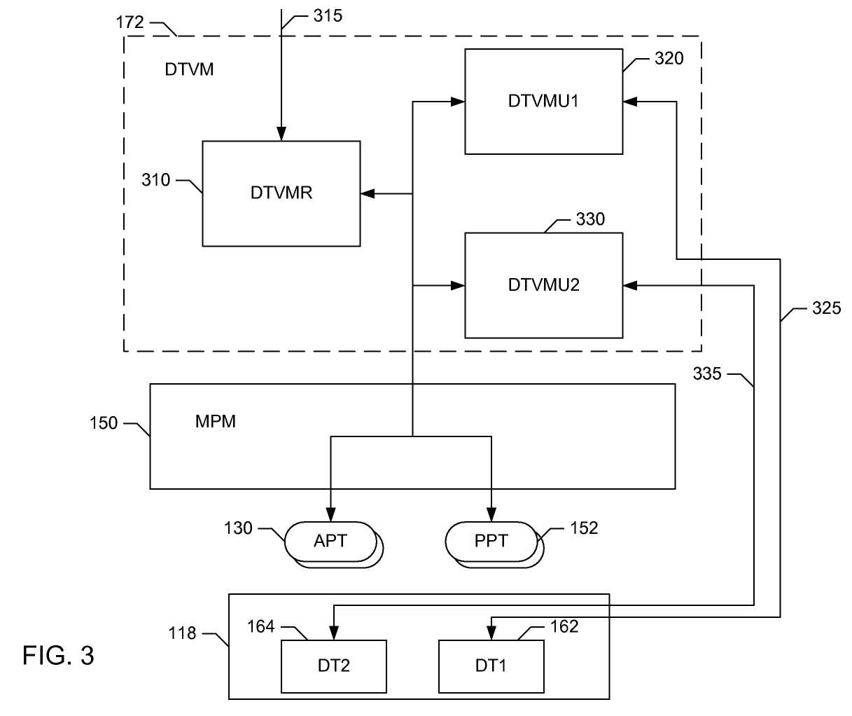

A block diagram of an example implementation of the DTVM 172 that may be used to implement the example platform 100 of FIG. 1 is illustrated in FIG. 3. The example DTVM 172 of FIG. 3 includes a DTVM registration module (DTVMR) 310 to process DT registration requests received via a DT registration interface 315. The DT registration interface 315 of the illustrated example is configured to interface with a DTAM, such as, for example, the DTAM 170 of FIGS. 1 and/or 2A. Thus, in some example implementations, the DT registration interface 315 and the DT registration interface 230 of FIG. 2A correspond to the same interface. In response to the DT registration request received from, for example, the DTAM 170, the DTVMR 310 of the illustrated example uses the virtual address information included in the registration request to map the memory region of DT1 162 (associated with agent 124) to the APT 130 and PPT 152 page tables. Additionally, the DTVMR 310 of the illustrated example uses the virtual address information included in the registration request to map the memory region of DT2 164 (associated with agent 124) to PPT 152. As such, the DT1 memory region (e.g., DT1 162) is accessible in both the unprotected context and the protected context via APT 130 and PPT 152, respectively, whereas the DT2 memory region (e.g., DT2 164) is accessible in only the protected context via PPT 152.

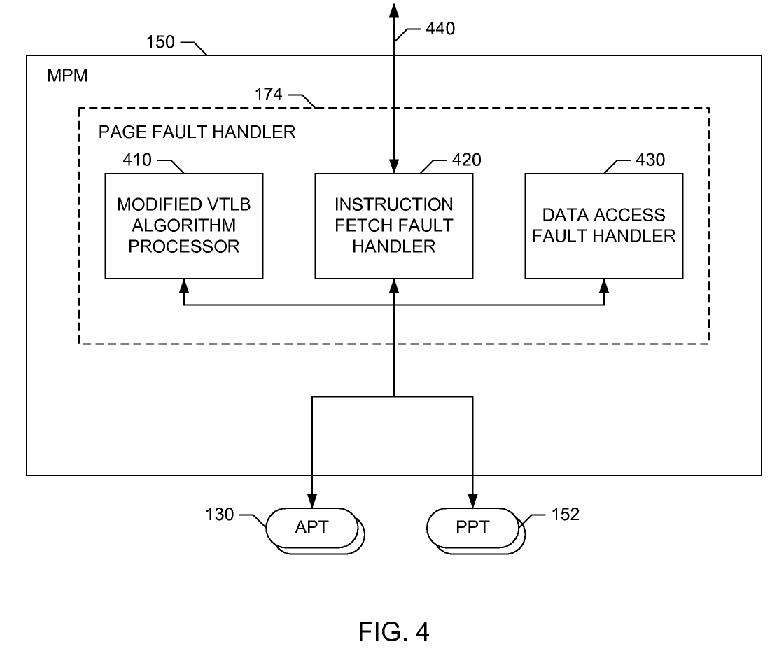

The example DTVM 172 of FIG. 3 also includes a DTVM DT1 update component (DTVMU1) 320 to update, for example, the APT 130 and PPT 152 page tables based on the entries included in the descriptor table DT1 162 associated with the agent 124. The DTVMU1 320 of the illustrated example is invoked by the example MPM 150 in response to an instruction fetch page fault caused by a context switch from the unprotected context to the protected context. As discussed in greater detail below in connections with FIG. 4, the instruction fetch page fault is detected and processed by an instruction fetch page fault handler operating in the MPM 150.

Upon invocation due to the instruction fetch page fault caused by the unprotected to protected context switch, the DTVMU1 320 of the illustrated example obtains each entry included in the descriptor table DT1 162 (via the DT1 memory interface 325) and maps the virtual addresses for each entry to PPT 152. In this way, the dynamic data memory regions corresponding to the entries in DT1 162 are accessible in the protected context (e.g., by the protected agent 124) through the protected page table PPT 152 without incurring an additional data access page fault. Additionally, for each entry in DT1 162, the DTVMU1 320 of the illustrated example unmaps the entry's virtual address from APT 130 unless the entry's type indicates that the virtual address is to be shared by both PPT 152 and APT 120. In this way, the dynamic data memory regions pointed to by the entries in DT1 162 are not accessible in the unprotected context (e.g., by an unprotected agent) through the APT 120 page table unless a particular buffer is specified as being shared in both the protected and unprotected contexts. Persons having ordinary skill in the art will appreciate that the DT1 memory interface 325 may be the same as, or different from, the DT1 memory interface 220 of FIG. 2A.

Similarly, the example DTVM 172 of FIG. 3 also includes a DTVM DT2 update component (DTVMU2) 330 to update, for example, the APT 130 and PPT 152 page tables based on the entries included in the descriptor table DT2 164 associated with the agent 124. The DTVMU2 330 of the illustrated example is invoked by the example MPM 150 in response to an instruction fetch page fault caused by a context switch from the unprotected context to the protected context. As discussed in greater detail below in connections with FIG. 4, the instruction fetch page fault is detected and processed by an instruction fetch page fault handler operating in the MPM 150.

Upon invocation due to the instruction fetch page fault caused by the protected to unprotected context switch, the DTVMU2 330 of the illustrated example obtains each entry included in the descriptor table DT2 164 (via the DT2 memory interface 335) and unmaps the virtual addresses for each entry from PPT 152. In this way, the dynamic data memory regions pointed to by the entries in DT2 164 are no longer accessible in the protected context (e.g., by the protected agent 124) through the protected page table PPT 152. Additionally, for each entry in DT2 164, the DTVMU2 330 of the illustrated example maps the entry's virtual address to APT 130. In this way, the dynamic data memory regions pointed to by the entries in DT1 162 are now accessible in the unprotected context (e.g., by an unprotected agent) through the APT 120 page table without incurring an additional data access page fault. Persons having ordinary skill in the art will appreciate that the DT2 memory interface 335 may be the same as, or different from, the DT2 memory interface 225 of FIG. 2A.

A block diagram of an example implementation of the page fault handler 174 that may be used to implement the example platform 100 of FIG. 1 is illustrated in FIG. 4. The example page fault handler 174 includes a modified VTLB algorithm processor 410 to process page faults caused in the unprotected context, an instruction fetch fault handler 420 to process instruction fetch page faults caused by context switches between unprotected and protected contexts or between protected contexts, and a data access faults handler 430 to process data access page faults caused by data accesses between unprotected and protected contexts or between protected contexts. The example modified VTLB algorithm processor 410 implements a modified VTLB procedure to process page faults occurring in unprotected contexts. As discussed above in connection with FIG. 1, a VTLB procedure implements a virtual translation lookaside buffer (TLB) for synchronization GPTs (e.g., such as the GPT 132) in a VM (e.g., such as the VM 120) with APTs (e.g., such as the APT 130) in a VMM (e.g., such as VMM 102). For example, the VTLB procedure allows the GOS 122 of the VM 120 to maintain its own GPT 132, while allowing the VMM 102 to use APT 130 to maintain control over the actual platform hardware 110.

When a page fault occurs, a standard VTLB procedure would process GPT 132 to determine the source of the page fault. If the faulty address causing the page fault is not mapped in the GPT 132, then the page fault occurred in the GOS 122 itself and the GOS 122 processes the page fault (e.g., by updating the mapping of GPT 132, issuing an exception, etc.). However, if the page fault arises due to a discrepancy between GPT 132 and APT 130 (e.g., because the faulty address is included in GPT 132 and, thus, the page fault resulted from the faulty address not being mapped in APT 130), the standard VTLB procedure synchronizes the corresponding entry of GPT 132 and APT 130 by mapping the faulty address to APT 130. Here, the example modified VTLB algorithm processor 410 implements the standard VTLB algorithms as just described for page faults occurring in the unprotected context, but with an additional modification. Specifically, when synchronizing the APT 130 with the GPT 132, the example modified VTLB algorithm processor 410 is configured to also check whether the faulty address is associated with protected memory before mapping the faulty address to the APT 130. The modified VTLB algorithm processor 410 of the illustrated example determines whether the faulty address is associated with protected memory based on a global data structure containing physical addresses corresponding to virtual addresses mapped in the PPT 152.

The example instruction fetch fault handler 420 included in the example page fault handler 174 of FIG. 4 handles instruction fetch page faults associated with protected contexts and invokes operation of the DTVM via a DTVM control interface 440 when such an instruction fetch page fault occurs. For example, depending on the type of instruction fetch page fault, the example instruction fetch fault handler 420 may invoke one or both of the DTVMU1 320 and/or the DTVMU2 330 included in the example DTVM 172 of FIGS. 1 and/or 3. In particular, the example instruction fetch fault handler 420 handles three types of instruction fetch page faults: (1) a context switch from an unprotected agent to a protected agent; (2) a context switch from a protected agent to an unprotected agent; and (3) a context switch from a protected agent to another protected agent.

In the case of an instruction fetch page fault caused by a context switch from an unprotected agent to a protected agent, the example instruction fetch fault handler 420 invokes a DTVMU1, such as, for example, the DTVMU1 320 of FIG. 3, to update the APT (e.g., such as APT 130) and the PPT (e.g., such as PPT 152) associated with the protected agent (e.g., such as the agent 124) to enable the protected agent to be executed in the protected context. Additionally, and as discussed above, the DTVMU1 updates the APT and PPT page tables to enable the protected agent to access specified dynamic data memory regions without incurring an additional data access page fault. After DTVMU1 320 is invoked, the example instruction fetch fault handler 420 opens memory protection for the protected agent (e.g., such as the agent 124) by setting the page table base address register (e.g., such as CR3 in the Intel® IA-32 architecture) to point to the PPT associated with the protected agent (e.g., such as PPT 152). Additionally, the example instruction fetch fault handler 420 may check whether the protected agent is being executed from an appropriate entry point before opening memory protection.

In the case of an instruction fetch page fault caused by a context switch from protected agent to unprotected agent, the example instruction fetch fault handler 420 invokes a DTVMU2, such as, for example, the DTVMU2 330 of FIG. 3, to update the APT (e.g., such as APT 130) and the PPT associated with the protected agent (e.g., such as PPT 152) to enable the unprotected agent to be executed in the unprotected context. Additionally, and as discussed above, the DTVMU2 updates the APT and PPT page tables to enable the unprotected agent to access specified dynamic data memory regions without incurring an additional data access page fault. After DTVMU2 330 is invoked, the example instruction fetch fault handler 420 closes (i.e., removes) memory protection for the protected agent (e.g., such as the agent 124) by setting the page table base address register (e.g., such as CR3 in the Intel® IA-32 architecture) to point to the APT (e.g., such as APT 130).

Finally, in the case of an instruction fetch page fault caused by a context switch from an originating protected agent to a destination protected agent, the example instruction fetch fault handler 420 performs a combination of the preceding two scenarios. In particular, the example instruction fetch fault handler 420 invokes a DTVMU2, such as, for example, the DTVMU2 330 of FIG. 3, to update the APT (e.g., such as APT 130) and the PPT associated with the originating protected agent and closes (i.e., removes) memory protection for the originating protected agent. The example instruction fetch fault handler 420 also invokes a DTVMU1, such as, for example, the DTVMU1 320 of FIG. 3, to update the APT (e.g., such as APT 130) and the PPT associated with the destination protected agent and opens memory protection for the destination protected agent.

The example data access fault handler 430 included in the example page fault handler 174 of FIG. 4 handles data access page faults associated with protected contexts. In particular, the example data access fault handler 430 handles three types of data access page faults: (1) access of unprotected data by a protected agent; (2) access of protected data by an unprotected agent; and (3) access of protected data associated with a first protected agent by a second protected agent. The latter two types of data access page faults are not allowed by the data access fault handler 430 of the illustrated example. As such, the example access fault handler 430 issues an appropriate error alert when either of the latter two types of data access page faults occurs.

However, the example access fault handler 430 allows data access page faults caused by a protected agent's access of unprotected data. This type of data access page fault occurs when a protected agent (e.g., such as the agent 124) accesses a dynamic data memory region that was not mapped at the time of agent invocation. Therefore, in this case the example data access fault handler 430 maps the faulty address for the dynamic page to the PPT associated with the protected agent (e.g., such as the PPT 152). Additionally, the example data access fault handler 430 stores information concerning the newly mapped dynamic data memory region in a protected agent database so that reference to the dynamic page can be removed from PPT when closing the memory protection. The protected agent database is a database containing the addresses and other information for each agent registered for memory protection. For example, the protected agent database may be stored in the example VMM 102 and updated when the agent (e.g., such as agent 124) registers for memory protection.

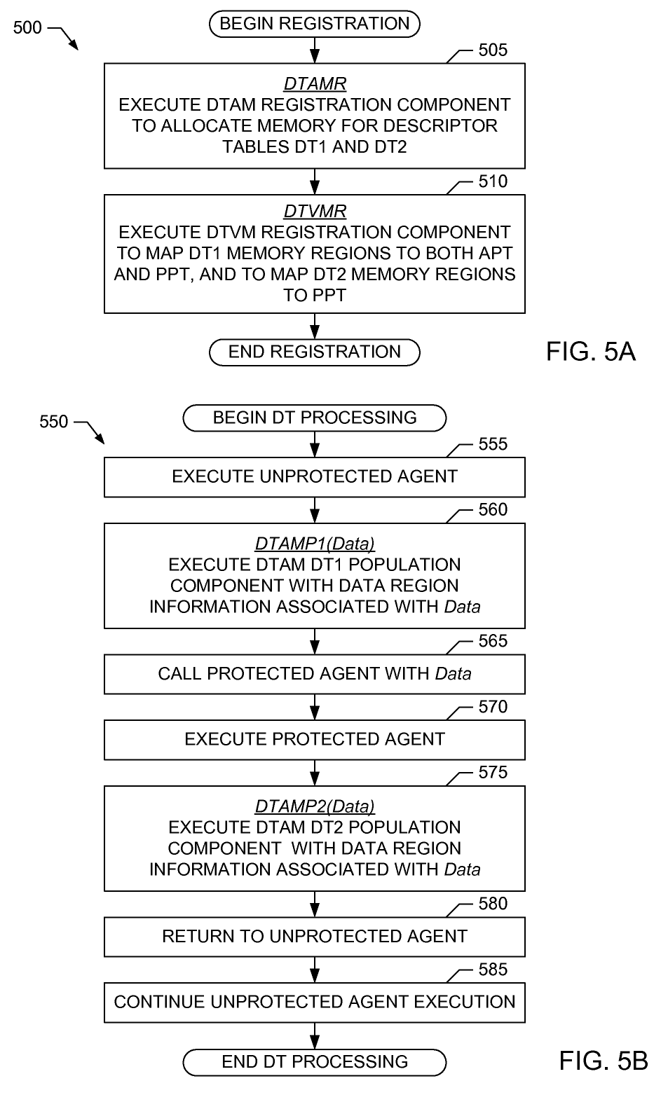

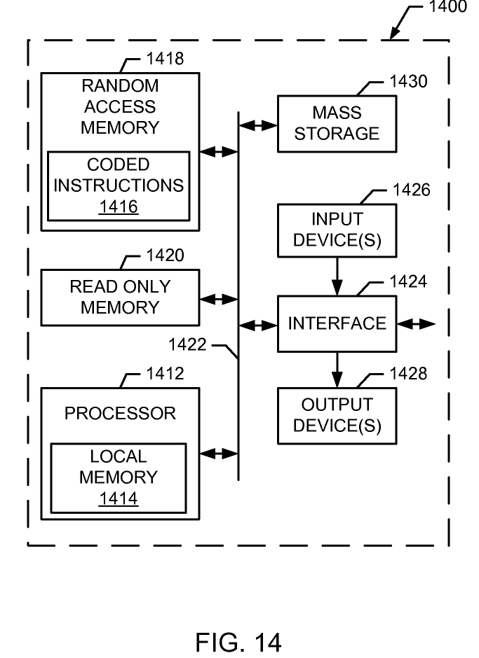

Flowcharts representative of example machine readable instructions that may be executed to implement the example DDMPM 160 of FIG. 1, the example DTAM 170 of FIGS. 1 and/or 2A, the example DTVM 172 of FIGS. 1 and/or 3, the example page fault handler 174 of FIGS. 1 and/or 4, the example DTAMR 210, the example DTAMP 1 235 and/or the example DTAMP2 245 of FIG. 2, the example DTVMR 310, the example DTVMU1 320 and/or the example DTVMU2 330 of FIG. 3, and/or the example modified VTLB algorithm processor 410, the example instruction fetch fault handler 420 and/or the example data access fault handler 430 are illustrated in FIGS. 5A-5B and 6-13. In these examples, the machine readable instructions represented by each flowchart may comprise one or more programs for execution by: (a) a processor, such as the processor 1412 shown in the example computer 1400 discussed below in connection with FIG. 14, (b) a controller, and/or (c) any other suitable device. The one or more programs may be embodied in software stored on a tangible medium such as, for example, a flash memory, a CD-ROM, a floppy disk, a hard drive, a DVD, or a memory associated with the processor 1412, but persons of ordinary skill in the art will readily appreciate that the entire program or programs and/or portions thereof could alternatively be executed by a device other than the processor 1412 and/or embodied in firmware or dedicated hardware (e.g., implemented by an application specific integrated circuit (ASIC), a programmable logic device (PLD), a field programmable logic device (FPLD), discrete logic, etc.). For example, any or all of the example DDMPM 160, the example DTAM 170, the example DTVM 172, the example page fault handler 174, the example DTAMR 210, the example DTAMP1 235, the example DTAMP2 245, the example DTVMR 310, the example DTVMU1 320, the example DTVMU2 330, the example modified VTLB algorithm processor 410, the example instruction fetch fault handler 420 and/or the example data access fault handler 430 could be implemented by any combination of software, hardware, and/or firmware. Also, some or all of the machine readable instructions represented by the flowchart of FIGS. 5A-5B and 6-13 may be implemented manually. Further, although the example machine readable instructions are described with reference to the flowcharts illustrated in FIGS. 5A-5B and 6-13, persons of ordinary skill in the art will readily appreciate that many other techniques for implementing the example methods and apparatus described herein may alternatively be used. For example, with reference to the flowcharts illustrated in FIGS. 5A-5B and 6-13, the order of execution of the blocks may be changed, and/or some of the blocks described may be changed, eliminated, combined and/or subdivided into multiple blocks.

Example machine readable instructions 500 and 550 that may be executed to implement the example descriptor table agent module (DTAM) 170 of FIG. 1 and/or 2A and portions of the example descriptor table VMM module (DTVM) 172 of FIGS. 1 and/or 3 to process descriptor tables associated with a protected programming agent are illustrated in FIGS. 5A and 5B, respectively. In particular, the example machine readable instructions 500 of FIG, 5A are configured to register the descriptor tables corresponding to the programming agent requesting registration for memory protection. The example machine readable instructions 550 of FIG. 5B are configured to populate the descriptor tables corresponding to a protected programming agent in preparation for context switches to and from the protected context provided for the protected programming agent.

Turning to FIG. 5A, the example machine readable instructions 500 may be executed when a programming agent (e.g., such as the agent 124 of FIG. 1), registers for memory protection. The example machine readable instructions 500 begin execution at block 505 at which the DTAM 170 of FIG. 1 receives a registration request for memory protection from, for example, the agent 124. In response to the receipt of the registration request, at block 505 the DTAM registration component (DTAMR) 210 of FIG. 2 allocates memory regions for the two descriptor tables DT1 162 and DT 164 associated with the agent 124. As discussed above, each entry 250 of the descriptor tables DT1 162 and DT 164 includes a virtual address 255 pointing to a dynamic data memory region to be made accessible between unprotected and protected contexts. Furthermore, at block 505 the DTAMR 210 initializes the entries to a known state indicating that the entries are not populated. For example, at block 505 the DTAMR 210 may initialize the type field 260 for each entry 250 to DT_INVALID as discussed above in connection with FIG. 2B.

Next, control proceeds to block 510 at which the DTVM registration module (DTVMR) 310 of FIG. 3 maps the memory region for the descriptor table DT1 162 to the page tables APT 130 and PPT 152. This mapping allows DT1 162 to be accessed by both unprotected agents and the protected agents (e.g., the protected agent 124) to allow these agents to specify dynamic data memory regions to be made accessible by another called protected agent. Additionally, at block 510 the DTVMR 310 maps the memory region for the descriptor table DT2 164 to PPT 152. This mapping allows DT2 164 to be accessed by only the associated protected agent (e.g., the protected agent 124) to specify dynamic data memory regions to be made accessible by unprotected agents upon a context switch from the protected context to the unprotected context. Execution of the example machine readable instructions 500 then ends.

Turning to FIG. 5B, the example machine readable instructions 550 may be executed when a programming agent (e.g., such as an unprotected programming agent) prepares to invoke a protected agent (e.g., such as the agent 124 of FIG. 1). Execution of the example machine readable instructions 550 begins at block 555 at which the unprotected agent begins execution. At some point during execution of the unprotected agent, control proceeds to block 560 at which the unprotected agent invokes the DTAM DT1 population component (DTAMP1) 235 of FIG. 2. At block 560 the unprotected agent provides the DTAMP1 235 with the virtual address and type field information corresponding to the dynamic data memory region (e.g., denoted as data in the illustrated example) to be made accessible by agent 124 in the protected context. The DTAMP1 235 uses the provided virtual address and type field information at block 560 to populate the virtual address 255 and the type field 260 of an entry 250 of DT1 162. The type field 260 at block 560 may be set to DT_PROTECTED if the dynamic data memory region data is to be accessible only in the protected context (e.g., only by the agent 124), or DT_SHARED if the dynamic data memory region data is to be shared across both the protected context and the unprotected context.

Next, control proceeds to block 565 at which the unprotected agent executing at block 555 invokes the protected agent 124 to process the dynamic data memory region data. A context switch to the protected context occurs and execution of the protected agent 124 begins at block 570. Next, prior to the protected agent 124 completing execution and returning to the calling unprotected agent, control proceeds to block 575 at which the protected agent 124 invokes the DTAM DT2 population component (DTAMP2) 245. At block 575 the protected agent 124 provides the DTAMP2 245 with the virtual address and type field information corresponding to the dynamic data memory region (e.g., denoted as data in the illustrated example) to be made accessible in the unprotected context by the unprotected agent. The DTAMP2 245 uses the provided virtual address and type field information at block 575 to populate the virtual address 255 and the type field 260 of an entry 250 of DT2 164. The type field 260 at block 575 may be DT_SHARED if the dynamic data memory region data is to be shared across both the protected context and the unprotected context. Otherwise, the dynamic data memory region data will be made accessible only in the unprotected context.

Next, control proceeds to block 580 at which the protected agent 124 executing at block 570 returns to its calling unprotected agent. The return at block 580 causes a context switch to the unprotected context. Control then proceeds to block 585 at which the unprotected agent continues execution. Execution of the example machine readable instructions 550 then ends.

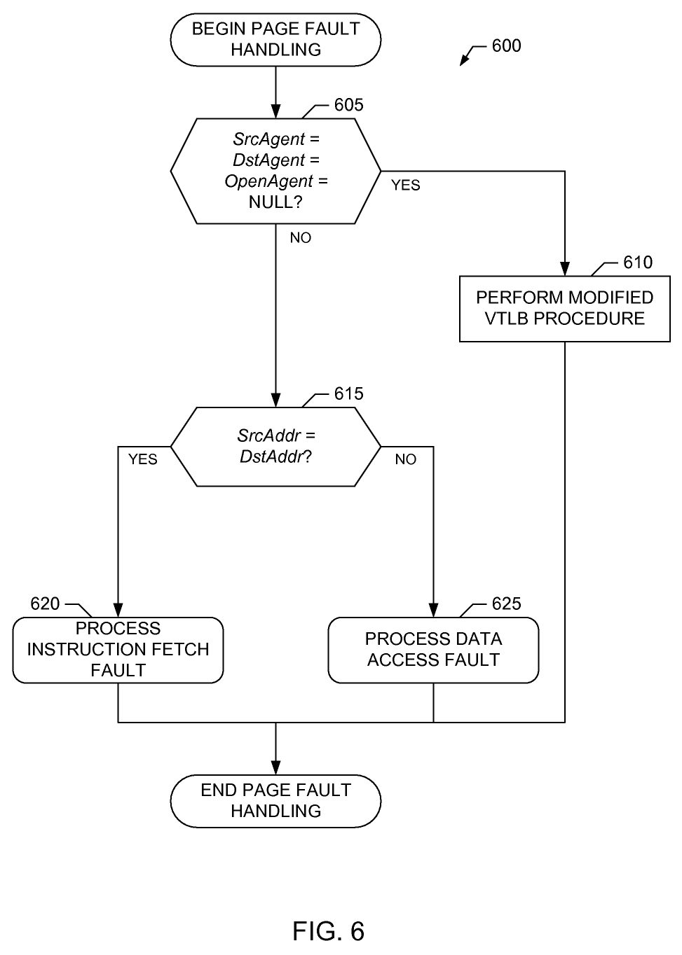

Example machine readable instructions 600 that may be executed to implement the example page fault handler 174 of FIGS. 1 and/or 4 are illustrated in FIG. 6. The example machine readable instructions 600 may be executed upon a page fault detected by, for example, the virtual machine monitor (VMM) 102 of FIG. 2. Execution of the machine readable instructions 600 begins at block 605 at which the page fault handler 174 determines whether the detected page fault is associated with a protected agent (e.g., such as the agent 124 of FIG. 1). For example, the VMM 102 may maintain a protected agent database that includes the address information of all programming agents registered for memory protection. When a page fault occurs, the page fault handler 174 may access the instruction pointer (e.g., such as EIP in the Intel® IA-32 architecture) to determine the source address of the page fault, denoted as SrcAddr in FIG. 6. The page fault handler 174 may also access the page fault address register (e.g., such as CR2 in the Intel® IA-32 architecture) to determine the destination address of the page fault, denoted as DstAddr in FIG. 6. The page fault handler 174 may then look up SrcAddr and DstAddr in the protected agent database to determine the respective source agent, denoted as SrcAgent in FIG. 6, and destination agent, denoted as DstAgent in FIG. 6, associated with the page fault. Furthermore, the page fault handler 174 may use the current address in the page table base address register (e.g., such as CR3 in the Intelφ IA-32 architecture) to determine whether a protected page table is active and, if so, the protected agent that is the current open agent, denoted as OpenAgent in FIG. 6.

Using the aforementioned information, at block 605 the page fault handler 174 determines whether the SrcAgent, the DstAgent and the OpenAgent associated with the page fault are all NULL. If the SrcAgent, the DstAgent and the OpenAgent are all NULL (block 605), then the page fault does not involve a protected agent and control proceeds to block 610. At block 610, the modified VTLB algorithm processor 410 included in the page fault handler 174 performs a modified virtual translation lookaside buffer (VTLB) procedure to process the page fault associated with unprotected agents. The modified VTLB procedure performed by the modified VTLB algorithm processor 410 at block 610 is discussed in greater detail above in connection with FIG. 4 and, therefore, is not discussed further herein. After the modified VTLB algorithm is completed at block 610, execution of the example machine readable instructions then ends.

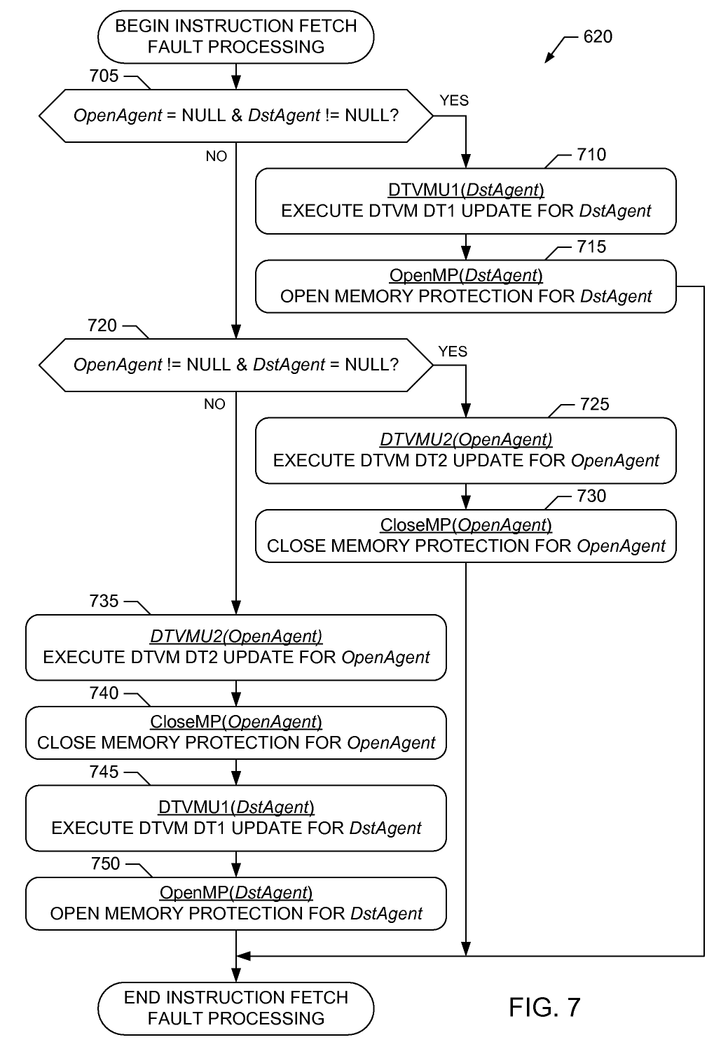

If, however, the SrcAgent, the DstAgent and the OpenAgent are not all NULL (block 605), the page fault involves at least one protected agent and control proceeds to block 615. At block 615 the page fault handler 174 determines whether the SrcAddr and the DstAddr associated with the page fault are the same. If the SrcAddr and the DstAddr are the same (block 615), then the page fault was caused by a fetch of the instruction in the instruction pointer and control proceeds to block 620. At block 620, the instruction fetch fault handler 420 included in the page fault handler 174 processes the detected instruction fetch fault. Because the instruction fetch fault processed at block 620 is associated with at least one protected agent, the instruction fetch fault handler 420 will invoke the appropriate components of the DTVM to make any specified dynamic data memory regions accessible between the unprotected context and the protected context. Example machine readable instructions that may be used to implement the processing at block 620 are illustrated in FIG. 7 and discussed in greater detail below. After the instruction fetch fault is processed at block 620, execution of the example machine readable instructions 600 then ends.

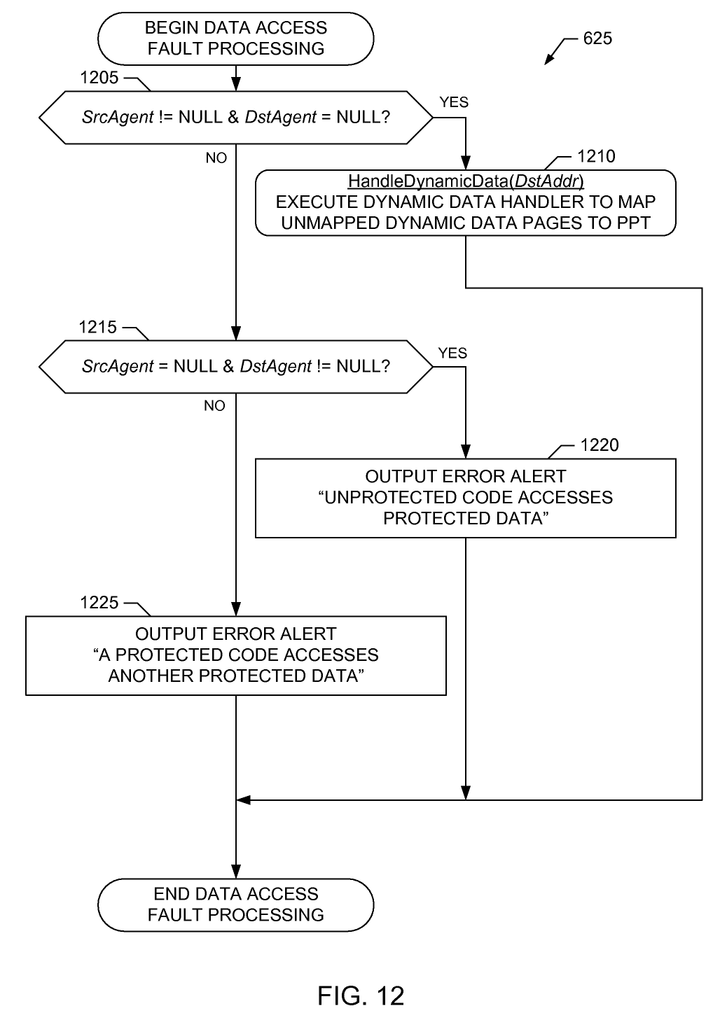

If, however, the SrcAddr and the DstAddr are not the same (block 615), then the page fault was caused by a data access at DstAddr performed by the instruction addressed by SrcAddr and, therefore, control proceeds to block 625. At block 625, the data access fault handler 430 included in the page fault handler 174 processes the data access page fault. Because the instruction fetch fault processed at block 620 is associated with at least one protected agent, the data access fault handler 430 determines whether access to the data memory regions referenced by the faulty region should be granted. Example machine readable instructions that may be used to implement the processing at block 625 are illustrated in FIG. 12 and discussed in greater detail below. After the data access fault is processed at block 625, execution of the example machine readable instructions 600 then ends.

Example machine readable instructions 620 that may be executed to implement the example instruction fetch fault handler 420 of FIG. 4 and/or the processing at block 620 of FIG. 6 are illustrated in FIG. 7. The example machine readable instructions 620 may be executed upon detection of an instruction fetch page fault by the example page fault handler 174 of FIGS. 1 and/or 4. Execution of the example machine readable instructions 620 begins at block 705 at which the instruction fetch fault handler 420 determines whether the OpenAgent associated with the page fault is NULL and the DstAgent associated with the page fault is not NULL. The OpenAgent is NULL when the current open agent associated with the page fault is an unprotected agent. Conversely, the DstAgent is not NULL with the destination agent associated with the page fault is a protected agent (e.g., such as the agent 124). Thus, if the OpenAgent is NULL and the DstAgent is not NULL (block 705), the page fault is associated with a context switch from an unprotected agent to a protected agent and control proceeds to block 710.

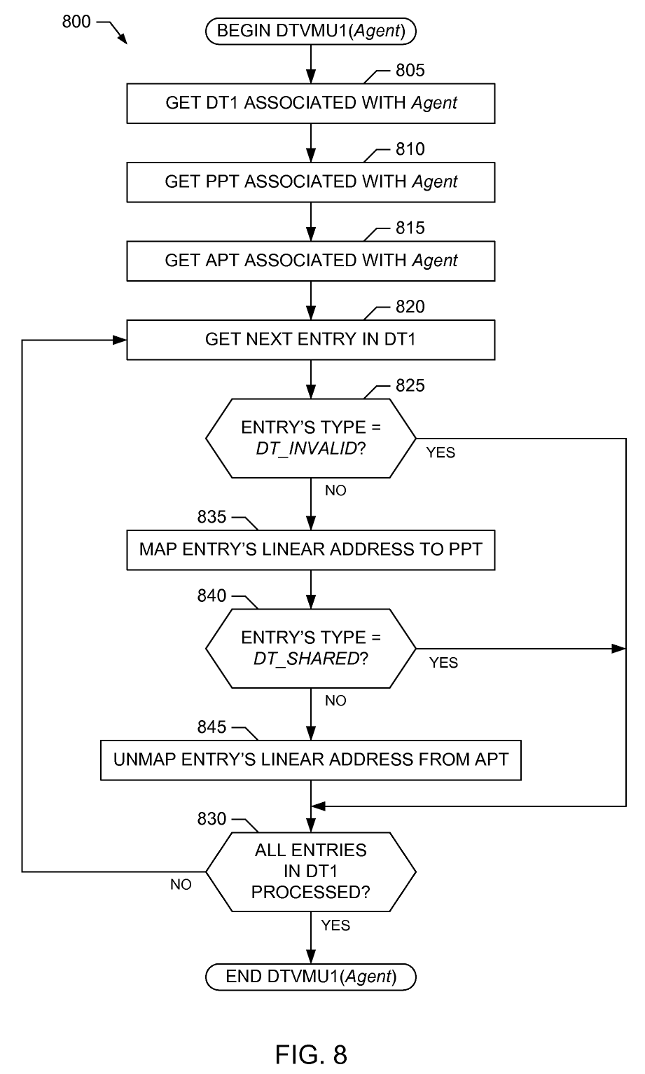

At block 710, the instruction fetch fault handler 420 invokes the DTVM DT1 update component (DTVMU1) 320 to update the active page table (e.g., such as APT 130) and the protected page table (e.g., such as PPT 152) associated with the protected destination agent DstAgent (e.g., such as the agent 124) to enable the DstAgent to be executed in the protected context. Additionally, the DTVMU1 320 updates the APT and PPT page tables corresponding to the DstAgent to enable this protected agent to access specified dynamic data memory regions without incurring an additional data access page fault. Example machine readable instructions 800 that may be used to implement the processing at block 710 are illustrated in FIG. 8 and discussed in greater detail below.

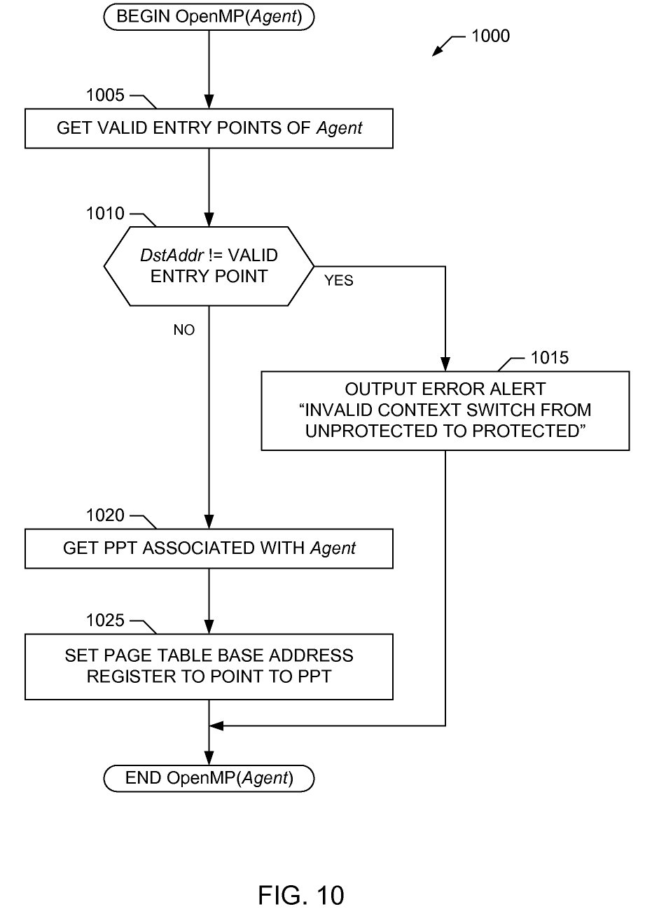

After the APT and PPT tables are updated at block 710, control proceeds to block 715 at which the instruction fetch fault handler 420 opens memory protection for the protected DstAgent (e.g., such as the agent 124). The instruction fetch fault handler 420 opens memory protection at block 715 by setting the page table base address register (e.g., such as CR3 in the Intel® IA-32 architecture) to point to the PPT associated with the protected DstAgent (e.g., such as PPT 152). Additionally, the instruction fetch fault handler 420 may check whether the protected DstAgent is being executed from an appropriate entry point before opening memory protection. Example machine readable instructions 1000 that may be used to implement the processing at block 715 are illustrated in FIG. 10 and discussed in greater detail below. After memory protection is opened at block 715, execution of the example machine readable instructions 620 then ends.

If, however, the OpenAgent is not NULL or the DstAgent is NULL (block 705), control proceeds to block 720 at which the instruction fetch fault handler 420 determines whether the OpenAgent is not NULL and the DstAgent is NULL. The OpenAgent is not NULL when the current open agent associated with the page fault is a protected agent (e.g., such as the agent 124). Conversely, the DstAgent is NULL when the destination agent associated with the page fault is an unprotected agent. Thus, if the OpenAgent is not NULL and the DstAgent is NULL (block 720), the page fault is associated with a context switch from a protected agent to an unprotected agent and control proceeds to block 725.

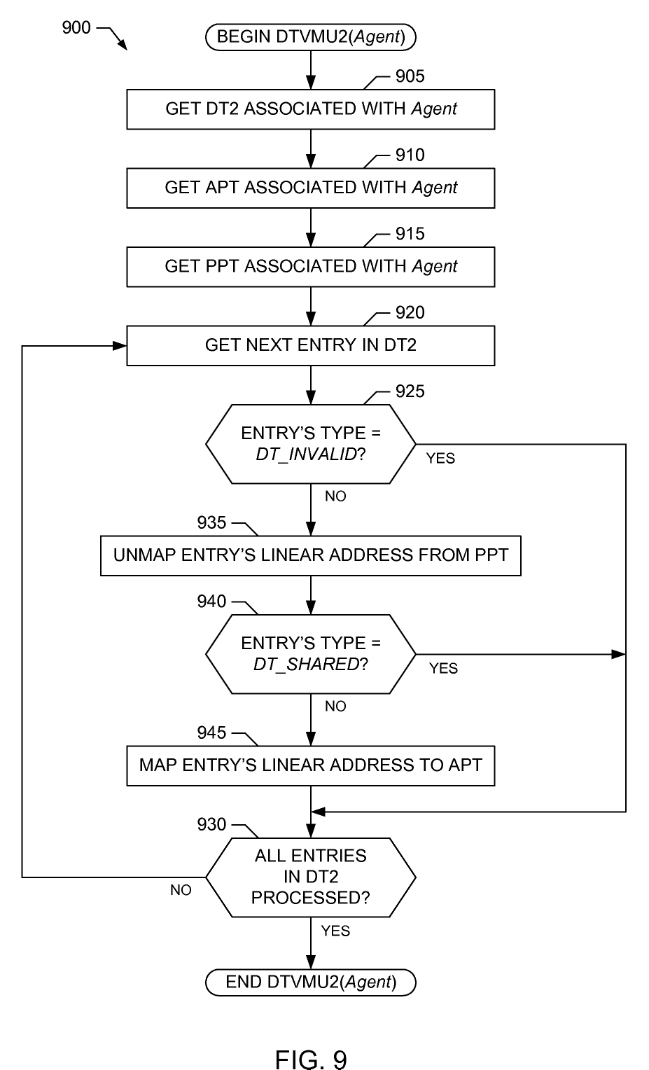

At block 725, the instruction fetch fault handler 420 invokes the DTVM DT2 update component (DTVMU2) 330 to update the active page table (e.g., such as APT 130) and the protected page table (e.g., such as PPT 152) associated with the protected open agent OpenAgent (e.g., such as the agent 124) to enable the unprotected DstAgent to be executed in the unprotected context. Additionally, the DTVMU1 updates the APT and PPT page tables corresponding to the OpenAgent to enable the unprotected agent DstAgent to access specified dynamic data memory regions after the context switch without incurring an additional data access page fault. Example machine readable instructions 900 that may be used to implement the processing at block 725 are illustrated in FIG. 9 and discussed in greater detail below.

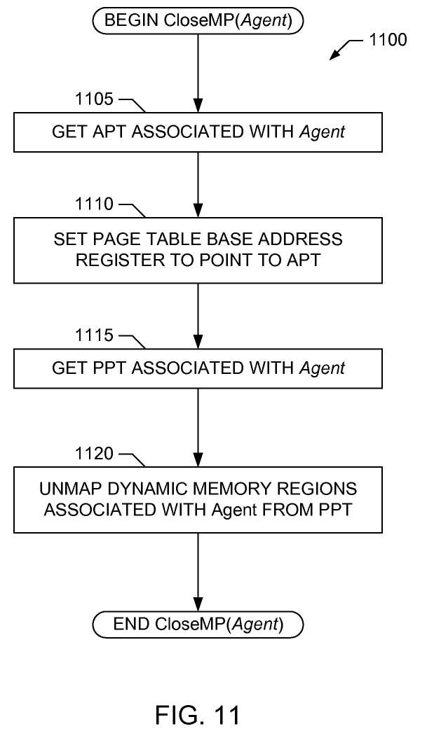

After the APT and PPT tables are updated at block 725, control proceeds to block 730 at which the instruction fetch fault handler 420 closes memory protection for the protected OpenAgent (e.g., such as the agent 124). The instruction fetch fault handler 420 closes memory protection at block 730 by setting the page table base address register (e.g., such as CR3 in the Intel® IA-32 architecture) to point to the APT (e.g., such as APT 130). Example machine readable instructions 1100 that may be used to implement the processing at block 730 are illustrated in FIG. 11 and discussed in greater detail below. After memory protection is opened at block 730, execution of the example machine readable instructions 620 then ends.

However, if at block 720 the instruction fetch fault handler 420 does not determine that the OpenAgent is not NULL and the DstAgent is NULL (block 720), then both the OpenAgent and the DstAgent must not be NULL. This conclusion follows because the example machine readable instructions 620 are invoked only if at least one of the OpenAgent or the DstAgent are protected agents. As such, the OpenAgent and the DstAgent cannot both be NULL and the preceding decisions at block 705 and 720 eliminated the cases in which only one of OpenAgent and DstAgent are not NULL. As such, the detected page fault corresponds to a context switch from the protected OpenAgent to the protected DstAgent and control proceeds to block 735.

At block 735, the instruction fetch fault handler 420 invokes the DTVMU2 330 to update the active page table and the protected page table associated with the protected open agent OpenAgent to enable the protected DstAgent to be executed initially in the unprotected context. Additionally, the DTVMU1 updates the APT and PPT page tables corresponding to the OpenAgent to enable the protected agent DstAgent to access specified dynamic data memory regions after the context switch without incurring an additional data access page fault. Example machine readable instructions 900 that may be used to implement the processing at block 735 are illustrated in FIG. 9 and discussed in greater detail below.

After the APT and PPT tables are updated at block 735, control proceeds to block 740 at which the instruction fetch fault handler 420 closes memory protection for the protected OpenAgent. The instruction fetch fault handler 420 closes memory protection at block 740 by setting the page table base address register (e.g., such as CR3 in the Intel® IA-32 architecture) to point to the APT (e.g., such as APT 130). Example machine readable instructions 1100 that may be used to implement the processing at block 740 are illustrated in FIG. 11 and discussed in greater detail below.

Next, control proceeds to block 745 at which the instruction fetch fault handler 420 invokes the DTVMU1 320 to update the active page table and the protected page table associated with the protected destination agent DstAgent to now enable the DstAgent to be executed in the protected context. Additionally, the DTVMU1 320 updates the APT and PPT page tables corresponding to the DstAgent to enable this protected agent to access specified dynamic data memory regions without incurring an additional data access page fault. Example machine readable instructions 800 that may be used to implement the processing at block 745 are illustrated in FIG. 8 and discussed in greater detail below.

After the APT and PPT tables are updated at block 745, control proceeds to block 750 at which the instruction fetch fault handler 420 opens memory protection for the protected DstAgent. The instruction fetch fault handler 420 opens memory protection at block 750 by setting the page table base address register (e.g., such as CR3 in the Intel® IA-32 architecture) to point to the PPT associated with the protected DstAgent. Additionally, the instruction fetch fault handler 420 may check whether the protected DstAgent is being executed from an appropriate entry point before opening memory protection. Example machine readable instructions 1000 that may be used to implement the processing at block 750 are illustrated in FIG. 10 and discussed in greater detail below. After memory protection is opened at block 750, execution of the example machine readable instructions 620 then ends.

Example machine readable instructions 800 that may be executed to implement the DTVM DT 1 descriptor table update component (DTVMU1) 320 of FIG. 3 and/or the processing at blocks 710 and/or 745 of FIG. 7 are illustrated in FIG. 8. The example machine readable instructions may be executed in response to an instruction fetch page fault associated with a context switch to a protected context for execution of a protected agent, denoted as Agent in FIG. 8 (e.g., such as the agent 124 of FIG. 1). The originating context prior to the context switch may be, for example, the unprotected context in which unprotected agents are executed, or another protected context associated with another protected agent.

Execution of the example machine readable instructions 800 begins at block 805 in response to an originating programming agent invoking the protected Agent, thereby causing an instruction fetch page fault to enable a context switch to the protected context for executing the protected Agent. To enable any specified dynamic data memory regions to be accessible across the context switch from the unprotected agent to the protected Agent, at block 805 the DTVMU1 320 accesses the DT1 descriptor table associated with Agent. For example, if the Agent corresponds to agent 124, the DT1 descriptor table accessed at block 805 corresponds to DT1 162. Prior to invoking the protected Agent 124, the originating agent would have populated DT1 162 with, for example, the virtual address and type field information corresponding to the dynamic data memory region to be made accessible by Agent 124 in the protected context. For example, prior to invoking the Agent 124, the originating agent could perform the processing at block 560 of FIG. 5A to populate the virtual address 255 and the type field 260 of entries 250 in DT1 162 corresponding to dynamic data memory regions to be made accessible by the protected Agent 124.

Next, control proceeds to block 810 at which the DTVMU1 320 accesses the active page table, such as, for example, the APT 130, associated with the protected Agent 124. As discussed above in connection with FIG. 1, the VMM 102 maintains the active page tables APT 130 to support address translation for accessing the physical memory in the platform hardware 110 (e.g., such as the host memory 118). At this point in the execution of the example machine readable instructions 800, the APT 130 is the page table being used by the VMM 102 to access physical memory for the originating agent. Control then proceeds to block 815 at which the DTVMU1 320 accesses the protected page table, such as, for example, the PPT 152, associated with the protected Agent 124. As discussed above in connection with FIG. 1, the MPM 150 creates the PPT 152 for accessing the protected memory corresponding to the Agent 124. Next, control proceeds to block 820.

At block 820, the DTVMU1 320 begins mapping the specified dynamic data memory regions in DT1 162 to the PPT 152 corresponding to the protected Agent 124 to enable these dynamic data memory regions to be accessible in the protected context without invoking additional data access page faults. In particular, at block 820 the DTVMU1 320 gets the next entry 250 in the DT1 162 that was accessed at block 805. Next, at block 825 the DTVMU1 320 determines whether the type field 260 of the DT entry 250 obtained at block 820 is set to DT_INVALID indicating that the DT entry 250 is not in use. If the type field 260 of the DT entry 250 is set to DT_INVALID (block 825), the entry 250 is not in use and control proceeds to block 830. If, however, the type field 260 of the DT entry 250 is not set to DT_INVALID (block 825), control proceeds to block 835 at which the DTVMU1 320 maps the virtual address 255 of the DT entry 250 to the PPT 152 associated with the protected Agent 124. This mapping makes the dynamic data memory region corresponding to the virtual address 255 accessible by the protected Agent 124 upon the context switch to the protected context without invoking another data access page fault. Control then proceeds to block 840.

At block 840, the DTVMU1 320 determines whether the type field 260 of the DT entry 250 obtained at block 820 is set to DT_SHARED indicating that the DT entry 250 is to be shared between the PPT 152 and the APT 130. If the type field 260 of the DT entry 250 is set to DT_SHARED (block 840), the mapping of the entry 250 is to remain in the APT 130 to enable sharing of the corresponding dynamic data memory region in both the unprotected and protected contexts. Control, therefore, proceeds to block 830. If, however, the type field 260 of the DT entry 250 is not set to DT_SHARED (block 840), control proceeds to block 845 at which the DTVMU1 320 unmaps the virtual address 255 of the DT entry 250 from the APT 130 associated with the protected Agent 124. This unmapping now invokes memory protection for the dynamic data memory region corresponding to the virtual address 255 because this memory region is no longer accessible by unprotected agents through the APT 130. Control then proceeds to block 830.

At block 830, the DTVMU1 320 determines whether all entries 250 in the descriptor table DT1 162 have been processed. If all entries 250 have not been processed (block 830), control returns to block 820 and blocks subsequent thereto at which the DTVMU1 320 begins mapping the next entry 250 in DT1 162. Otherwise, if all entries 250 have been processed (block 830), execution of the example machine readable instructions 800 then ends.

Example machine readable instructions 900 that may be executed to implement the DTVM DT2 descriptor table update component (DTVMU2) 330 of FIG. 3 and/or the processing at blocks 725 and/or 735 of FIG. 7 are illustrated in FIG. 9. The example machine readable instructions may be executed in response to an instruction fetch page fault associated with a context switch from a protected context for execution of a protected agent, denoted as Agent in FIG. 9 (e.g., such as the agent 124 of FIG. 1), to a destination context. The destination context after to the context switch may be, for example, the unprotected context in which unprotected agents are executed, or another protected context associated with another protected agent.

Execution of the example machine readable instructions 900 begins at block 905 in response the protected Agent invoking an unprotected agent or another protected agent, thereby causing an instruction fetch page fault to enable a context switch away from the protected context in which the protected Agent is currently executing. To enable any dynamic data memory regions to be accessible across the context switch from the protected Agent to the unprotected agent or another protected agent, at block 905 the DTVMU2 330 accesses the DT2 descriptor table associated with Agent. For example, if the Agent corresponds to agent 124, the DT2 descriptor table accessed at block 905 corresponds to DT2 164. Prior to invoking the unprotected agent or another protected agent, the protected Agent 124 would have populated DT2 164 with, for example, the virtual address and type field information corresponding to the dynamic data memory regions to be made accessible outside of the protected context associated with Agent 124. For example, prior to invoking the unprotected agent or another protected agent, the Agent 124 could perform the processing at block 575 of FIG. 5A to populate the virtual address 255 and the type field 260 of entries 250 in DT2 164 corresponding to dynamic data memory regions to be made accessible outside the protected context of the protected Agent 124.

Next, control proceeds to block 910 at which the DTVMU2 330 accesses the active page table, such as, for example, the APT 130, associated with the protected Agent 124. As discussed above in connection with FIG. 1, the VMM 102 maintains the active page tables APT 130 to support address translation for accessing the physical memory in the platform hardware 110 (e.g., such as the host memory 118). The APT 130 is the page table being used by the VMM 102 to access physical memory outside the protected context associated with the protected Agent 124. Control then proceeds to block 915 at which the DTVMU2 330 accesses the protected page table, such as, for example, the PPT 152, associated with the protected Agent 124. As discussed above in connection with FIG. 1, the MPM 150 creates the PPT 152 for accessing the protected memory corresponding to the Agent 124. At this point in the execution of the example machine readable instructions 900, the PPT 152 is the page table being used by the VMM 102 to access physical memory for the protected Agent 124. Next, control proceeds to block 920.

At block 920, the DTVMU2 330 begins mapping the specified dynamic data memory regions in DT2 164 to the APT 130 corresponding to the protected Agent 124 to enable these dynamic data memory regions to be accessible outside the protected context without invoking additional data access page faults. In particular, at block 920 the DTVMU2 330 gets the next entry 250 in the DT2 164 that was accessed at block 905. Next, at block 925 the DTVMU2 330 determines whether the type field 260 of the DT entry 250 obtained at block 920 is set to DT_INVALID indicating that the DT entry 250 is not in use. If the type field 260 of the DT entry 250 is set to DT_INVALID (block 925), the entry 250 is not in use and control proceeds to block 930. If, however, the type field 260 of the DT entry 250 is not set to DT_INVALID (block 925), control proceeds to block 935 at which the DTVMU2 330 unmaps the virtual address 255 of the DT entry 250 from the PPT 152 associated with the protected Agent 124. This unmapping removes the memory protection associated with the dynamic data memory region corresponding to the virtual address 255 upon the context switch from the protected context. Control then proceeds to block 940.

At block 940, the DTVMU2 330 determines whether the type field 260 of the DT entry 250 obtained at block 920 is set to DT_SHARED indicating that the DT entry 250 is to be shared between the PPT 152 and the APT 130. If the type field 260 of the DT entry 250 is set to DT_SHARED (block 940), the mapping of the entry 250 is already in the APT 130 because the corresponding dynamic data memory region is shared in both the unprotected and protected contexts. Control, therefore, proceeds to block 830. If, however, the type field 260 of the DT entry 250 is not set to DT_SHARED (block 940), control proceeds to block 945 at which the DTVMU2 330 maps the virtual address 255 of the DT entry 250 to the APT 130 associated with the protected Agent 124. This mapping now enables the dynamic data memory region corresponding to the virtual address 255 to be accessible outside the protected context of the protected Agent 124 through the APT 130 without invoking an additional data access page fault. Control then proceeds to block 930.

At block 930, the DTVMU2 330 determines whether all entries 250 in the descriptor table DT2 164 have been processed. If all entries 250 have not been processed (block 930), control returns to block 920 and blocks subsequent thereto at which the DTVMU2 330 begins mapping the next entry 250 in DT2 164. Otherwise, if all entries 250 have been processed (block 930), execution of the example machine readable instructions 900 then ends.

Example machine readable instructions 1000 that may be executed to perform the processing at blocks 715 and/or 750 of FIG. 7 to open memory protection for a protected agent are illustrated in FIG. 10. The example machine readable instructions 1000 may be executed in response to an instruction fetch page fault to perform a context switch to a protected context for execution of a protected agent, denoted as Agent in FIG. 10 (e.g., such as the agent 124 of FIG. 1). The originating context prior to the context switch may be, for example, the unprotected context in which unprotected agents are executed, or another protected context associated with another protected agent.

Execution of the example machine readable instructions 1000 begins at block 1005 at which the page fault handler 174 of FIGS. 1 and/or 4 obtains the valid entry points for executing the protected Agent, such as, for example, the agent 124. The valid entry points may be obtained by the page fault handler 174 from, for example, a protected agent database maintained by the VMM 102 for each agent registered for memory protection. Control then proceeds to block 1010 at which the page fault handler 174 examines the destination address, denoted as DstAddr in FIG. 10, associated with the instruction fetch page fault that invoked execution of the example machine readable instructions 1000. If the page fault handler 174 determines that the DstAddr is not a valid entry point into the protected Agent 124 (block 1010), control proceeds to block 1015 at which the page fault handler 174 outputs an error alert. The error alert at block 1015 may indicate that memory protection has been violated due to, for example, an invalid context switch from the unprotected context to the protected context. Execution of the example machine readable instructions 1000 then ends.

If, however, the page fault handler 174 determines that the DstAddr is a valid entry point into the protected Agent 124 (block 1010), control proceeds to block 1020 at which the page fault handler 174 accesses the protected page table (PPT) 152, associated with the protected Agent 124. As discussed above in connection with FIG. 1, the MPM 150 creates the PPT 152 for accessing the protected memory corresponding to the Agent 124. Next, control proceeds to block 1025 at which the page fault handler 174 sets the page table base address pointer (e.g., such as CR3 in the Intel® IA-32 architecture) of the platform hardware 110 to point to PPT 152. By setting the page table base address pointer to point to PPT 152, the page fault handler 174 opens memory protection and switches the context to the protected context because the VMM 102 will now use the PPT 152 to access physical memory for the protected Agent 124. Execution of the example machine readable instructions 1000 then ends.

Example machine readable instructions 1100 that may be executed to perform the processing at blocks 730 and/or 740 of FIG. 7 to close memory protection for a protected agent are illustrated in FIG. 11. The example machine readable instructions 1100 may be executed in response to an instruction fetch page fault to perform a context switch away from a protected context at the conclusion of executing a protected agent, denoted as Agent in FIG. 11 (e.g., such as the agent 124 of FIG. 1). The destination context after to the context switch may be, for example, the unprotected context in which unprotected agents are executed, or another protected context associated with another protected agent.

Execution of the example machine readable instructions 1100 begins at block 1105 at which the page fault handler 174 of FIGS. 1 and/or 4 accesses the active page table, such as, for example, the APT 130, associated with the protected Agent 124. As discussed above in connection with FIG. 1, the VMM 102 maintains the active page tables APT 130 to support address translation for accessing the physical memory in the platform hardware 110 (e.g., such as the host memory 118). The APT 130 is the page table used by the VMM 102 to access physical memory outside the protected context associated with the protected Agent 124.

Control then proceeds to block 1110 at which page fault handler 174 sets the page table base address pointer (e.g., such as CR3 in the Intel® IA-32 architecture) of the platform hardware 110 to point to APT 130. By setting the page table base address pointer to point to APT 130, the page fault handler 174 closes memory protection and switches the context to the unprotected context because the VMM 102 will now use the APT 130 to access physical memory for unprotected agents.

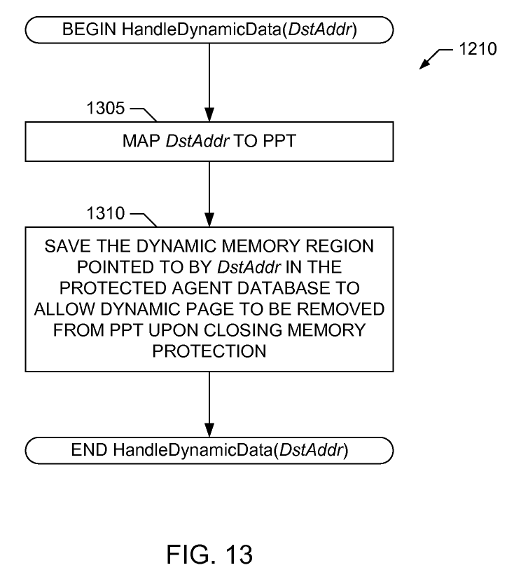

Next, control proceeds to block 1115 at which the page fault handler 174 accesses the protected page table (PPT) 152, associated with the protected Agent 124. As discussed above in connection with FIG. 1, the MPM 150 creates the PPT 152 for accessing the protected memory corresponding to the Agent 124. Control then proceeds to block 1120 at which the page fault handler 174 unmaps any remaining dynamic data memory regions from PPT 152. Such dynamic data memory regions may have been mapped to PPT 152 in response to accesses of unprotected memory regions by the Agent 124 while executing in the protected context. To determine the mappings in PPT 152 corresponding to the remaining dynamic data memory regions, the page fault handler 174 may consult a protected agent database maintained by the VMM 102 and updated, for example, by the example machine readable instructions 1300 of FIG. 13 discussed in greater detail below. After the processing at block 1120 completes, execution of the example machine readable instructions 1100 then ends.

Example machine readable instructions 625 that may be executed to implement the example data access fault handler 430 of FIG. 4 and/or the processing at block 625 of FIG. 6 are illustrated in FIG. 12. The example machine readable instructions 625 may be executed upon detection of a data access page fault by the example page fault handler 174 of FIGS. 1 and/or 4. Execution of the example machine readable instructions 625 begins at block 1205 at which the data access fault handler 430 determines whether the SrcAgent associated with the page fault is not NULL and the DstAgent associated with the page fault is NULL. The SrcAgent is not NULL when the source agent associated with the page fault is a protected agent (e.g., such as the agent 124). Conversely, the DstAgent is NULL when the destination address associated with the page fault points to an unprotected data memory region. Thus, if the SrcAgent is not NULL and the DstAgent is NULL (block 1205), the page fault is associated with a context switch occurring when the protected SrcAgent, such as, for example, agent 124, accesses a dynamic data memory region that was not mapped at the time of agent invocation, and control proceeds to block 1210.

At block 1210, the data access fault handler 430 performs a handle dynamic data procedure to map the faulty address DstAddr for the accessed unprotected dynamic data memory regions to the protected page table (PPT) 164 associated with the protected SrcAgent. Additionally, as part of the handle dynamic data procedure performed at block 1210, the data access fault handler 430 stores information concerning the newly mapped dynamic data memory region in a protected agent database so that reference to the mapped memory region can be removed from PPT 164 when closing the memory protection. Example machine readable instructions that may be used to implement the processing at block 1210 are illustrated in FIG. 13 and discussed in greater detail below. After processing at block 1210 completes, execution of the example machine readable instructions 625 then ends.

If, however, the data access fault handler 430 does not determine that the SrcAgent is not NULL and the DstAgent is NULL (block 1205), the page fault is associated with an invalid memory access of a protected data memory region. This conclusion follows because the example machine readable instructions 625 are invoked only if at least one of the SrcAgent or the DstAgent are associated with protected agents. As such, the SrcAgent and the DstAgent cannot both be NULL and the preceding decision at block 1205 eliminated the case in which the SrcAgent is not NULL and DstAgent is NULL. Therefore, the only two remaining scenarios have the SrcAgent being NULL and DstAgent not being NULL, or the SrcAgent not being NULL and DstAgent not being NULL. If the SrcAgent is NULL and DstAgent is not NULL, then the SrcAgent is an unprotected agent attempting to access a protected memory region. If the SrcAgent is not NULL and DstAgent is not NULL, then the SrcAgent is a protected agent attempting to access another agent's protected memory region. Both of these types of data memory accesses are not allowed by the data access fault handler 430. Thus, control proceeds to block 1215 at which the data access fault handler 430 determines which type of invalid data memory access has occurred.

Specifically, at block 1215 the data access fault handler 430 determines whether the SrcAgent is NULL and the DstAgent is not NULL. If the SrcAgent is NULL and the DstAgent is not NULL (block 1215), the SrcAgent is an unprotected agent attempting to access a protected memory region and control proceeds to block 1220. At block 1220 the data access fault handler 430 outputs an error alert. The error alert at block 1220 may indicate that memory protection has been violated due to, for example, the unprotected SrcAgent's attempt to access a protected data memory region. Execution of the example machine readable instructions 625 then ends.

If, however, at block 1215 the data access fault handler 430 does not determine that the SrcAgent is NULL and the DstAgent is not NULL, then the SrcAgent is not NULL and DstAgent is not NULL. This indicates that the SrcAgent is a protected agent attempting to access another agent's protected memory region and, therefore, control proceeds to block 1225. At block 1225 the data access fault handler 430 outputs an error alert. The error alert at block 1225 may indicate that memory protection has been violated due to, for example, the protected SrcAgent's attempt to access another agent's protected data memory region. Execution of the example machine readable instructions 625 then ends.

Example machine readable instructions 1210 that may be executed to perform the processing at block 1210 of FIG. 12 to handle unmapped dynamic data memory accessed by a protected agent are illustrated in FIG. 13. The example machine readable instructions 1210 may be executed in response to access of unmapped dynamic data memory, pointed to by the address DstAddr in FIG. 13, by a protected agent, such as, for example, the agent 124 of FIG. 1. Execution of the example machine readable instructions 1210 begins at block 1305 at which the page fault handler 174 maps the dynamic data memory regions pointed to by DstAddr to the protected page table (PPT) 152 associated with the protected agent 124 whose data memory access invoked execution of the example machine readable instructions 1210. As discussed above in connection with FIG. 1, the MPM 150 creates the PPT 152 for accessing the protected memory corresponding to the agent 124.

Next, control proceeds to block 1310 at which page fault handler 174 updates a protected agent database maintained by the VMM 102. The update performed at block 1310 includes saving the address information for the dynamic data memory region mapped at block 1305 in the area of the protected agent database used to store information for the protected agent 124. By storing the address information of the dynamic data memory region mapped at block 1305, the page fault handler 174 and/or the MPM 150 can remove the references to this mapped data region from the PPT 152 when the protected agent 124 concludes execution and memory protection is closed. Execution of the example machine readable instructions 1210 then ends.

FIG. 14 is a block diagram of an example computer 1400 capable of implementing the apparatus and methods disclosed herein. The computer 1400 can be, for example, a server, a personal computer, a personal digital assistant (PDA), an Internet appliance, a DVD player, a CD player, a digital video recorder, a personal video recorder, a set top box, or any other type of computing device. The example computer 1400 may be used, for example, to implement the example platform 100 of FIG. 1.

The system 1400 of the instant example includes a processor 1412 such as a general purpose programmable processor. The processor 1412 includes a local memory 1414, and executes coded instructions 1416 present in the local memory 1414 and/or in another memory device. The processor 1412 may execute, among other things, the machine readable instructions represented in FIGS. 5A-5B through FIG. 13. The processor 1412 may be any type of processing unit, such as one or more microprocessors from the Intel® Centrino® family of microprocessors, the Intel® Pentium® family of microprocessors, the Intel® Itanium® family of microprocessors, and/or the Intel XScale® family of processors. Of course, other processors from other families are also appropriate.

The processor 1412 is in communication with a main memory including a volatile memory 1418 and a non-volatile memory 1420 via a bus 1422. The volatile memory 1418 may be implemented by Static Random Access Memory (SRAM), Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1420 may be implemented by flash memory and/or any other desired type of memory device. Access to the main memory 1418, 1420 is typically controlled by a memory controller (not shown).

The computer 1400 also includes an interface circuit 1424. The interface circuit 1424 may be implemented by any type of interface standard, such as an Ethernet interface, a universal serial bus (USB), and/or a third generation input/output (3GIO) interface.

One or more input devices 1426 are connected to the interface circuit 1424. The input device(s) 1426 permit a user to enter data and commands into the processor 1412. The input device(s) can be implemented by, for example, a keyboard, a mouse, a touchscreen, a track-pad, a trackball, an isopoint and/or a voice recognition system.

One or more output devices 1428 are also connected to the interface circuit 1424. The output devices 1428 can be implemented, for example, by display devices (e.g., a liquid crystal display, a cathode ray tube display (CRT)), by a printer and/or by speakers. The interface circuit 1424, thus, typically includes a graphics driver card.

The interface circuit 1424 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 1400 also includes one or more mass storage devices 1430 for storing software and data. Examples of such mass storage devices 1430 include floppy disk drives, hard drive disks, compact disk drives and digital versatile disk (DVD) drives. The mass storage device 1430 may implement active page tables (APTs) 130, the guest page tables (GPTs) 132 and/or the protected page tables (PPTs) 152 of FIG. 1. Alternatively, the volatile memory 1418 may implement the APTs 130, the GPTs 132 and/or the PPTs 152.

As an alternative to implementing the methods and/or apparatus described herein in a system such as the device of FIG. 14, the methods and or apparatus described herein may be embedded in a structure such as a processor and/or an ASIC (application specific integrated circuit).

Finally, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method to protect a dynamic memory region comprising:
mapping protected memory regions to a protected page table for address translation associated with a protected agent;
updating the protected page table with address information corresponding to the dynamic memory region during a context switch from execution of an unprotected agent to execution of the protected agent when the dynamic memory region was allocated for the unprotected agent prior to the context switch; and
accessing the dynamic memory region during execution of the protected agent based on the address information in the protected page table without causing a subsequent context switch.

2. A method as defined in claim 1 wherein the protected page table is accessible for address translation only during the execution of the protected agent.

3. A method as defined in claim 1 wherein the context switch is associated with an instruction fetch page fault.

4. A method as defined in claim 1 further comprising mapping unprotected memory regions to an active page table for address translation associated with the unprotected agent, and wherein a page table base address register is configured to point to the active page table during execution of the unprotected agent and to the protected page table during execution of the protected agent after the context switch.

5. A method as defined in claim 1 wherein updating the protected page table comprises:
including the address information corresponding to the dynamic memory region in an entry in a descriptor table;
accessing the entry in the descriptor table from the protected agent; and
mapping the address information to the protected page table.

6. A method as defined in claim 5 further comprising adding type information corresponding to the dynamic memory region to the descriptor table, wherein the type information indicates whether the dynamic memory region is accessible by at least one of only the protected agent or both of the protected agent and the unprotected agent.

7. A method as defined in claim 6 further comprising:
mapping unprotected memory regions to an active page table for address translation associated with the unprotected agent; and
removing the address information corresponding to the dynamic memory region from the active page table during the context switch when the type information indicates that the dynamic memory region is accessible by only the protected agent.

8. A method as defined in claim 1 further comprising:
mapping unprotected memory regions to an active page table for address translation associated with the unprotected agent; and
removing the address information corresponding to the dynamic memory region from the active page table during the context switch.

9. A method as defined in claim 1 wherein the context switch is a first context switch and further comprising:
mapping unprotected memory regions to an active page table for address translation associated with the unprotected agent; and
when the dynamic memory region is allocated for the protected agent, updating the active page table with address information corresponding to the dynamic memory region and removing the address information from the protected page table during a second context switch from execution of the protected agent to execution of the unprotected agent.

10. A method as defined in claim 9 wherein a page table base address register is configured to point to the protected page table during execution of the protected agent and to the active page table during execution of the protected agent after the second context switch.

11. A method as defined in claim 9 wherein updating the active page table comprises:
including the address information corresponding to the dynamic memory region in an entry in a descriptor table;
accessing the entry in the descriptor table; and
mapping the address information to the active page table.

12. A method as defined in claim 9 wherein the first context switch is associated with a first instruction fetch page fault and the second context switch is associated with a second instruction fetch page fault.

13. A method as defined in claim 1 wherein the protected page table is managed by a virtual machine monitor.

14. A method as defined in claim 1 wherein the dynamic memory region comprises a dynamic data memory region.

15. An article of manufacture storing machine readable instructions which, when executed, cause a machine to:
map protected memory regions to a protected page table for address translation associated with a protected agent;
update the protected page table with address information corresponding to the dynamic memory region during a context switch from execution of an unprotected agent to execution of the protected agent when the dynamic memory region was allocated for the unprotected agent prior to the context switch; and
access the dynamic memory region during execution of the protected agent based on the address information in the protected page table without causing a subsequent context switch.

16. An article of manufacture as defined in claim 15 wherein the context switch is associated with an instruction fetch page fault.

17. An article of manufacture as defined in claim 15 wherein the machine readable instructions, when executed, further cause the machine to update the protected page table by:
including the address information corresponding to the dynamic memory region in an entry in a descriptor table;
accessing the entry in the descriptor table; and
mapping the address information to the protected page table.

18. An article of manufacture as defined in claim 15 wherein the machine readable instructions, when executed, further cause the machine to:
map unprotected memory regions to an active page table for address translation associated with the unprotected agent; and
remove the address information corresponding to the dynamic memory region from the active page table during the context switch.

19. An article of manufacture as defined in claim 15 wherein the context switch is a first context switch and wherein, when the dynamic memory region is allocated for the protected agent, the machine readable instructions, when executed, further cause the machine to:
map unprotected memory regions to an active page table for address translation associated with the unprotected agent; and
update the active page table with address information corresponding to the dynamic memory region and remove the address information from the protected page table during a second context switch from execution of the protected agent to execution of the unprotected agent.

20. An article of manufacture as defined in claim 19 wherein the machine readable instructions, when executed, further cause the machine to update the active page table by:
including the address information corresponding to the dynamic memory region in an entry in a descriptor table;
accessing the entry in the descriptor table; and
mapping the address information to the active page table.

21. An article of manufacture as defined in claim 19 wherein the first context switch is associated with a first instruction fetch page fault and the second context switch is associated with a second instruction fetch page fault.

22. A system comprising:
a virtual machine monitor to manage an active page table for memory address translation associated with an unprotected agent and to manage a protected page table for address translation associated with a protected agent;
a descriptor table virtual machine monitor module to update the protected page table with address information corresponding to a dynamic memory region accessible by the unprotected agent to allow the dynamic memory region to be accessible by the protected agent upon a switch to a protected context for executing the protected agent, wherein the address information is stored in a descriptor table; and
a memory to store the descriptor table.

23. A system as defined in claim 22 wherein the dynamic data memory region comprises a dynamic data memory region.

24. A system as defined in claim 22 wherein the descriptor table comprises a plurality of descriptor table entries, wherein a descriptor table entry comprises a virtual address field and a type field, and wherein the descriptor table entry stores the address information corresponding to the dynamic memory region by storing a page aligned base address for the dynamic memory region in the virtual address field.

25. A system as defined in claim 24 wherein the descriptor table entry further stores the address information corresponding to the dynamic memory region by storing a type indicator for the dynamic memory region in the type field, wherein the type indicator indicates whether the dynamic memory region is accessible by at least one of only the protected agent or both of the protected agent and the unprotected agent.

26. A system as defined in claim 22 wherein the address information is first address information, the dynamic memory region is a first dynamic memory region and the descriptor table is a first descriptor table, and wherein the descriptor table virtual machine monitor module is further configured to update the active page table with second address information corresponding to a second dynamic memory region accessible by the protected agent to allow the second dynamic memory region to be accessible by the unprotected agent upon a switch to an unprotected context for executing the unprotected agent, wherein the second address information is stored in a second descriptor table.

27. A system as defined in claim 22 further comprising a descriptor table agent module to allocate the descriptor table in response to a request for memory protection by the protected agent.

28. A system as defined in claim 27 wherein the descriptor table agent module is further configured to update an entry in the descriptor table with the address information corresponding to the dynamic data memory prior to the switch to the protected context.

29. A system as defined in claim 22 further comprising a page fault handler to perform the switch to the protected context in response to an instruction fetch page fault associated with the protected agent.

30. A system as defined in claim 29 wherein a page table base address register points to the active page table during execution of the unprotected agent, and wherein the page fault handler is configured to perform the switch to the protected context by setting the page table base address register to point to the protected page table.
